(19) United States
(12) Patent Application Publication
(10) Pub. No.: US 2026/0323089 A1
(43) Pub. Date: Oct. 15, 2026

(54) ENCODING AND DECODING METHOD, POINT CLOUD ENCODER, POINT CLOUD DECODER, AND STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhuo MA, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/713,409

(22) Filed: Jun. 18, 2026

Related U.S. Application Data
(63) Continuation of application No. PCT/CN2023/142918, filed on Dec. 28, 2023.

(51) Int. Cl. H04N 19/597; H04N 19/13; H04N 19/159; H04N 19/503; H04N 19/593

(52) U.S. Cl. CPC H04N 19/597; H04N 19/13; H04N 19/159; H04N 19/503; H04N 19/593

(57) ABSTRACT

The present application discloses an encoding and decoding method, a point cloud encoder, a point cloud decoder, and a storage medium. At an encoding end, when a current child node enables an inter-frame prediction mode, a target entropy encoding parameter set of the current child node is determined on the basis of occupancy information of a predicted child node; a target entropy encoding parameter of the current child node is determined from the target entropy encoding parameter set on the basis of context information of the current child node; and entropy encoding is performed on the occupancy information of the current child node on the basis of the target entropy encoding parameter, and an obtained encoded bit is written into a bitstream. At a decoding end, the same method is used to determine a target entropy decoder, and entropy decoding is performed on occupancy information.

### CROSS-REFERENCE TO RELATED APPLICATIONS

This application is a continuation of International Application No. PCT/CN2023/142918, filed on Dec. 28, 2023, the disclosure of which is hereby incorporated by reference in its entirety.

### TECHNICAL FIELD

Embodiments of this application relate to the field of point cloud encoding and decoding technologies, and in particular, to an encoding method, a decoding method, a point cloud encoder, a point cloud decoder, and a storage medium.

### BACKGROUND

Currently, in a coding framework of geometry-based point cloud compression (G-PCC), geometric information of a point cloud and attribute information corresponding to a point in the point cloud are separately encoded. In the G-PCC coding framework, geometry coding mainly includes octree geometry coding, Trisoup geometry coding, and predictive geometry coding.

In the octree geometry coding technology, encoding and decoding occupancy information based on context information of a node to be encoded has problems of high computational complexity and low encoding and decoding efficiency.

### SUMMARY

Embodiments of this application provide an encoding method, a decoding method, a point cloud encoder, a point cloud decoder, and a storage medium. During inter prediction, the best entropy encoding/decoder parameter set is selected for a current child node by fully utilizing inter prediction information, and the best entropy encoding/decoder parameter is further selected, based on context information, for encoding, thereby reducing a bit rate and improving encoding and decoding efficiency.

The technical solutions in embodiments of this application may be implemented as follows.

According to a first aspect, an embodiment of this application provides a decoding method, applied to a point cloud decoder. The method includes:
in a case that an inter prediction mode is enabled for a current child node, determining a target entropy decoding parameter set for the current child node based on occupancy information of a prediction child node of the current child node in a reference frame;
determining a target entropy decoding parameter for the current child node from the target entropy decoding parameter set based on context information of the current child node; and
performing entropy decoding on a bitstream based on the target entropy decoding parameter to determine occupancy information of the current child node.

According to a second aspect, an embodiment of this application provides an encoding method, applied to a point cloud encoder. The method includes:
in a case that an inter prediction mode is enabled for a current child node, determining a target entropy encoding parameter set for the current child node based on occupancy information of a prediction child node of the current child node in a reference frame;
determining a target entropy encoding parameter for the current child node from the target entropy encoding parameter set based on context information of the current child node; and
performing entropy encoding on occupancy information of the current child node based on the target entropy encoding parameter, and writing obtained encoded bits into a bitstream.

According to a third aspect, an embodiment of this application provides a point cloud encoder. The point cloud encoder includes: a first determining unit and an encoding unit, where the first determining unit is configured to: in a case that an inter prediction mode is enabled for a current child node, determine a target entropy encoding parameter set for the current child node based on occupancy information of a prediction child node of the current child node in a reference frame; and determine a target entropy encoding parameter for the current child node from the target entropy encoding parameter set based on context information of the current child node; and
the encoding unit is configured to perform entropy encoding on occupancy information of the current child node based on the target entropy encoding parameter, and write obtained encoded bits into a bitstream.

According to a fourth aspect, an embodiment of this application provides a point cloud encoder. The point cloud encoder includes a first memory and a first processor, where
the first memory is configured to store a computer program runnable on the first processor; and
the first processor is configured to execute the method according to the second aspect when running the computer program.

According to a fifth aspect, an embodiment of this application provides a point cloud decoder. The point cloud decoder includes a second determining unit and a decoding unit, where the second determining unit is configured to: in a case that an inter prediction mode is enabled for a current child node, determine a target entropy decoding parameter set for the current child node based on occupancy information of a prediction child node of the current child node in a reference frame; and determine a target entropy decoding parameter for the current child node from the target entropy decoding parameter set based on context information of the current child node; and
the decoding unit is configured to perform entropy decoding on a bitstream based on the target entropy decoding parameter to determine occupancy information of the current child node.

According to a sixth aspect, an embodiment of this application provides a point cloud decoder. The point cloud decoder includes a second memory and a second processor, where
the second memory is configured to store a computer program runnable on the second processor; and
the second processor is configured to execute the method according to the first aspect when running the computer program.

According to a seventh aspect, an embodiment of this application provides a computer-readable storage medium, where the computer-readable storage medium stores a bitstream generated by using the encoding method.

According to an eighth aspect, an embodiment of this application provides a computer-readable storage medium, where the computer-readable storage medium stores a computer program, and the computer program, when executed, causes the method according to the first aspect or the method according to the second aspect to be implemented.

### BRIEF DESCRIPTION OF DRAWINGS

FIG. 1 is a schematic diagram of a network architecture of point cloud encoding and decoding.

FIG. 2 is a schematic diagram of a composition framework of a G-PCC encoder.

FIG. 3 is a schematic diagram of a composition framework of a G-PCC decoder.

FIG. 4 is a schematic diagram of an implementation framework of an OBUF technology.

FIG. 5 is a schematic diagram of an implementation process of an OBUF technology.

FIG. 6 is a schematic diagram illustrating dynamic adjustment of context priorities.

FIG. 7 is a schematic diagram of scanning order of child nodes in a current node.

FIG. 8 is a schematic diagram of a process for constructing inter-frame context information.

FIG. 9 is a schematic diagram of intra-frame and inter-frame entropy encoding processes based on an OBUF technology.

FIG. 10 is a schematic flowchart 1 of a decoding method according to an embodiment of this application.

FIG. 11 is a schematic diagram of distribution of child neighbor nodes and face-sharing parent neighbor nodes of a child node 0.

FIG. 12 is a schematic diagram of a distribution sequence of 20 parent neighbor nodes of a child node 0.

FIG. 13 is a schematic flowchart 2 of a decoding method according to an embodiment of this application.

FIG. 14 is a schematic flowchart 1 of an encoding method according to an embodiment of this application.

FIG. 15 is a schematic flowchart 2 of an encoding method according to an embodiment of this application.

FIG. 16 is a schematic structural diagram of a point cloud encoder according to an embodiment of this application.

FIG. 17 is a schematic diagram of a specific hardware structure of a point cloud encoder according to an embodiment of this application.

FIG. 18 is a schematic structural diagram of a point cloud decoder according to an embodiment of this application.

FIG. 19 is a schematic diagram of a specific hardware structure of a point cloud decoder according to an embodiment of this application.

FIG. 20 is a schematic structural diagram of a codec system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

The names and terms used in embodiments of this application are described before providing a more detailed description of embodiments of this application, and the names and terms used in embodiments of this application are applicable to the following explanations:
point cloud compression (PCC);
geometry-based point cloud compression (G-PCC or GPCC);
video-based point cloud compression (V-PCC or VPCC);
octree;
triangle soup (Trisoup);
K nearest neighbor (KNN);
level of detail (LOD);
predicting transform;
lifting transform;
region adaptive hierarchal transform (RAHT); and
context-based adaptive binary arithmetic coding (CABAC).

A point cloud is a three-dimensional representation of a surface of an object. A point cloud (data) of a surface of an object may be collected by using a collection device such as an optoelectronic radar, a LiDAR, a laser scanner, or a multi-angle camera.

The point cloud is a set of massive three-dimensional points, and a point in the point cloud may include position information of the point and attribute information of the point. For example, the position information of the point may be three-dimensional coordinate information of the point, and may also be referred to as geometric information of the point. For example, the attribute information of the point may include color information, reflectivity, and/or the like. For example, the color information may be information in any color space. For example, the color information may be RGB information, where R represents red (R), G represents green (G), and B represents blue (B). For another example, the color information may be luma and chroma (YCbCr, YUV) information, where Y denotes luma, Cb (U) denotes blue chroma, and Cr (V) denotes red chroma.

A point in a point cloud obtained according to a laser measurement principle may include three-dimensional coordinate information of the point and laser reflectance of the point. For another example, a point in a point cloud obtained according to a photography measurement principle may include three-dimensional coordinate information of the point and color information of the point. For another example, a point in a point cloud obtained according to a laser measurement principle in combination with a photography measurement principle may include three-dimensional coordinate information of the point, laser reflectance of the point, and color information of the point.

According to acquisition methods, point clouds may be classified into the following three types:
Type 1: Static point cloud, for which an object is static, and a device for acquiring the point cloud is also static.
Type 2: Dynamic point cloud, for which an object is moving, but a device for acquiring the point cloud is static.
Type 3: dynamically acquired point cloud, where a device for acquiring the point cloud is moving.

For example, according to usage, point clouds are classified into the following two types:
type 1: machine perception point cloud, which may be used in scenarios such as an autonomous navigation system, a real-time inspection system, a geographic information system, a visual sorting robot, and a disaster relief robot; and
type 2: human eye point cloud, which may be used in point cloud application scenarios such as a digital cultural heritage, free viewpoint broadcasting, three-dimensional immersive communication, and three-dimensional immersive interaction.

Since a point cloud is a collection of massive points, storing the point cloud consumes a large amount of memory, and is also not conducive to transmission. In addition, there is no such bandwidth that may support direct transmission of a point cloud without compression at a network layer. Therefore, it is necessary to compress the point cloud.

To date, a point cloud encoding framework that may be used for compressing a point cloud may be a G-PCC coding framework or a V-PCC coding framework provided by the Moving Picture Experts Group (MPEG), or may be an AVS-PCC coding framework provided by the Audio Video Standard (AVS). The G-PCC coding framework may be used to compress the static point cloud of type 1 and the dynamically acquired point cloud of type 3, and the V-PCC coding framework may be used to compress the dynamic point cloud of type 2. The G-PCC coding framework is mainly described in embodiments of this application.

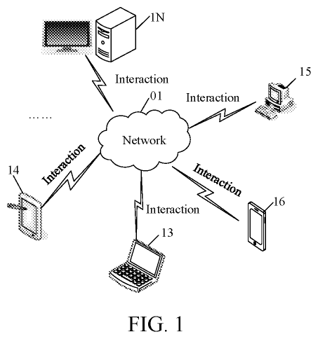

Embodiments of this application provide a network architecture of a point cloud encoding and decoding system including a decoding method and an encoding method. FIG. 1 is a schematic diagram of a network architecture for point cloud encoding and decoding according to an embodiment of this application. As shown in FIG. 1, the network architecture includes one or more electronic devices 13 to 1N and a communications network 01, where the electronic devices 13 to 1N may perform video interaction with each other by using the communications network 01. In an implementation process, the electronic device may be various types of devices that have a point cloud encoding and decoding function. For example, the electronic device may include a mobile phone, a tablet computer, a personal computer, a personal digital assistant, a navigator, a digital telephone, a video telephone, a television, a sensing device, a server, or the like. This is not limited in embodiments of this application. A decoder or an encoder in embodiments of this application may be the foregoing electronic device.

The electronic device in embodiments of this application has a point cloud encoding and decoding function, and generally includes a point cloud encoder (that is, an encoder) or a point cloud decoder (that is, a decoder).

The following describes a related technology by using a G-PCC encoding and decoding framework as an example.

It may be understood that, in a G-PCC encoding and decoding framework for a point cloud, to-be-encoded point cloud data is first partitioned into a plurality of slices through slicing (slice). In each slice, geometric information of each point cloud and attribute information corresponding to the point cloud are separately encoded.

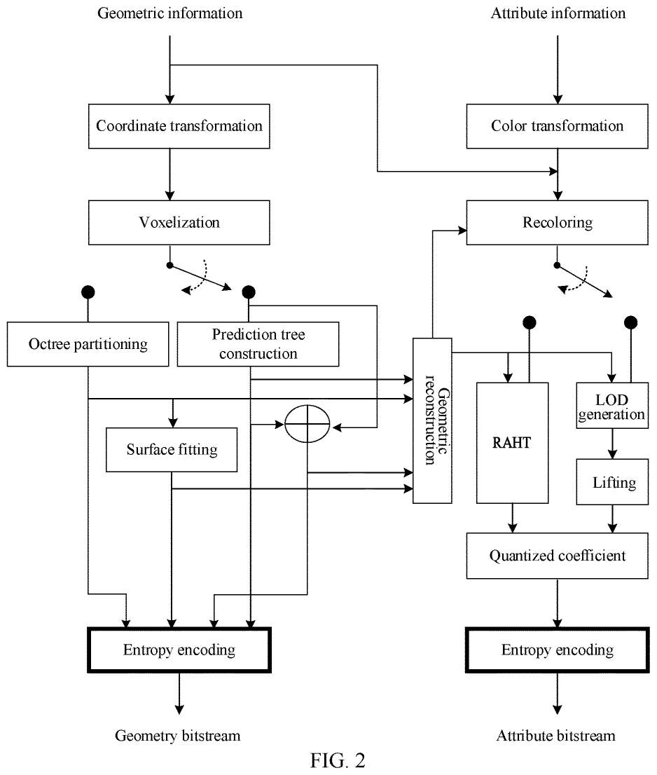

FIG. 2 is a schematic diagram of a composition framework of a G-PCC encoder. As shown in FIG. 2, in a geometry encoding process, geometric information is subjected to coordinate transformation, such that the whole point cloud is contained within a bounding box, and the geometric information is then subjected to quantization. The quantization in this step mainly plays a scaling function. Due to rounding during quantization, a part of the point cloud has identical geometric information. Then, it is determined whether to remove duplicate points based on a parameter. The process of quantization and removal of duplicate points is also referred to as a voxelization process. Next, octree partitioning or prediction tree construction is performed on the bounding box. In this process, entropy encoding is performed on points in leaf nodes obtained by partitioning, to generate a binary geometry bitstream; or entropy encoding (surface fitting based on vertices) is performed on vertices generated by partitioning to generate a binary geometry bitstream. In an attribute encoding process, after geometry encoding is completed and the geometry information is reconstructed, color transform is required to be performed first, and color information (namely, attribute information) is transformed from RGB color space to YUV color space. Then, the point cloud is colored again by using the reconstructed geometric information, so that attribute information that is not encoded corresponds to the reconstructed geometric information. Attribute encoding is mainly performed on color information. In a color information encoding process, there are mainly two transformation methods: One method is distance-based lifting transform depending on LOD partitioning, and the other method is to directly perform RAHT transform. In both the two methods, the color information is transformed from a spatial domain to a frequency domain, a high-frequency coefficient and a low-frequency coefficient are obtained by transformation, finally the high-frequency coefficient and the low-frequency coefficient are quantized, and then entropy encoding is performed on the quantized coefficients, to generate a binary attribute bitstream.

FIG. 3 is a schematic diagram of a composition framework of a G-PCC decoder. As shown in FIG. 3, for an acquired binary bitstream, a geometric bitstream and an attribute bitstream in the binary bitstream are first separately decoded. To decode the geometry bitstream, entropy decoding is first performed, then one of the following manners is selected: octree partition-surface reconstruction estimation or prediction tree construction, followed by geometric reconstruction-coordinate inverse transformation, and geometric information of a point cloud may be obtained. To decode the attribute bitstream, entropy decoding and dequantization are first performed, then one of the following manners is selected: RAHT transformation or LOD partition-lifting transform, finally color inverse transformation is performed, and the attribute information of the point cloud may be obtained. Data of the point cloud to be encoded can be restored based on the geometric information and the attribute information.

It should be noted that, as shown in FIG. 2 or FIG. 3, currently G-PCC geometry coding may be octree geometry coding, Trisoup geometry coding, or predictive geometry coding. Details are as follows.

### (a) Octree Geometry Coding

On an encoding side, coordinate transform is first performed on geometric information, so that the whole point cloud is included in a bounding box determined by two extreme points (0, 0, 0) and (2d, 2d, 2d), and then voxelization, namely, quantization, rounding operation, or removal of duplicate points (determined depending on a parameter) is performed. Next, octree partitioning is continuously performed on sub-cubes that are not empty (including points in the point cloud) in the bounding box in a breadth-first traversal sequence. In a same octree depth, one node is partitioned into eight child nodes and partitioning continues to be performed until a leaf node obtained by partitioning becomes a unit cube of 1×1×1. 8-bit (Bits) binary code generated for determining whether a sub-cube is occupied by a point (where 1 indicates being occupied and 0 indicates being unoccupied) is called occupancy code. Occupancy code of each node is encoded to generate a binary bitstream.

On a decoding side, parsing is continuously performed in a breadth-first traversal sequence to obtain occupancy code of each node, and the node is sequentially partitioned continuously until a unit cube of 1×1×1 is obtained. Then parsing is performed to obtain a quantity of points included in each leaf node, and finally geometry-reconstructed point cloud information is obtained.

### (b) Trisoup Geometry Coding

On the encoding side, octree partitioning is first performed. Different from the octree geometry encoding, this method does not require partitioning a point cloud level by level into bottom-level leaf nodes with a side length of 1×1×1, but instead the point cloud is partitioned into leaf nodes with a specified side length. Then, surface information formed by voxels in the nodes is represented by a series of triangle meshes. In GPCC, a parameter Trisoup node size may be used to represent a size of a block in which a triangular mesh is located. When the Trisoup node size is greater than 0, a voxel set in a node is represented by using a geometric mesh, and at most twelve vertices generated by a geometric mesh and twelve edges of the block are referred to as vertices. Vertex coordinates of respective blocks are sequentially encoded to generate a binary bitstream.

On the decoding side, to decode geometric coordinates of the point cloud from the triangular mesh of the node, it is necessary to check whether each voxel in the node cube intersects with the triangular mesh. This technique is called triangular rasterization, that is, intersection tests are performed using six unit vectors (0, 0, 1), (0, 0, 1), (0, 0, 1), (0, 0, 1), (0, 0, 1), and (0, 0, 1), to determine whether respective unit vectors intersect with the triangular mesh. If an intersection occurs, an intersection point is calculated and a decoded cube is output. A quantity of points generated in the decoder is determined by a mesh distance d.

### (c) Predictive Geometry Coding

On an encoding side, points in an input point cloud are first sorted. Sorting methods currently used include disordering, Morton ordering, azimuth ordering, and radial distance ordering. On the encoding side, a prediction tree structure is established in two different modes: a high-latency slow mode (KD tree) and a low-latency fast mode (assigning the points to different lasers by using LiDAR calibration information, and establishing a prediction tree structure based on different lasers). Next, each node in the prediction tree is traversed based on the prediction tree structure, geometric position information of the node is predicted by selecting different prediction modes to obtain a prediction residual, and the prediction residual is quantized by using a quantization parameter. Finally, through continuous iterations, prediction residuals of position information of prediction tree nodes, the prediction tree structure, the quantization parameter, and the like are encoded to generate a binary bitstream.

On the decoding side, bitstreams are continuously parsed to reconstruct a prediction tree structure, geometric position prediction residual information and a quantization parameter of each prediction node are obtained through the parsing, and the prediction residual is dequantized to obtain reconstructed geometric position information of each node, and finally geometric reconstruction on the decoding side is completed.

It should be further noted that, in a possible implementation of a related technology, an encoder currently used in G-PCC is context-based adaptive binary arithmetic encoding CABAC. This is a form of entropy encoder widely used in video encoding. Similar to conventional arithmetic encoding, in CABAC, a recursive interval partitioning method is used for encoding representation. Because CABAC is adaptive encoding, a probability model is adjusted as symbols are processed, and a statistical characteristic of an information source is fully considered, greatly improving encoding efficiency. The CABAC encoder may include three parts: binarization, context modeling, and binary arithmetic encoding. Details are as follows.
(1) Binarization: Binarization is a process of mapping a given non-binary syntax element into a binary sequence, namely, a bin string. If the input syntax element is a binary syntax element, binary processing is omitted, and data is directly transmitted to a next step through a bypass.
(2) Context modeling: The encoder assigns a proper probability model to each input bin based on a value of a previously encoded syntax element or bin. This process is the context modeling.
(3) Binary arithmetic encoding: There are two encoding modes available for selection: regular encoding mode and bypass encoding mode. In the regular encoding mode (Regular Coding Mode), the bin of the syntax element is transmitted together with the probability model assigned to the bin to the binary arithmetic encoder for encoding and the context model is updated based on the value of the bin. This is adaptation in encoding. Another mode is the bypass encoding mode, which does not need to assign a specific probability model to each bin. An input bin is encoded directly by using a simple bypass encoder, which can speed up the entire encoding and decoding process.
   1. Optimal Binarization with Update on the Fly (OBUF) Technology

The OBUF technology is to quickly and accurately map a series of discrete states of occupancy information of context nodes to a fixed quantity of adaptive entropy encoders (namely, probability models) through a mapping relationship lookup table (LUT). In this way, context information is no longer in a one-to-one correspondence with probability models. Instead, a fixed quantity of probability models are updated as currently encoded syntax elements are processed, and the mapping relationship is updated after each encoding operation.

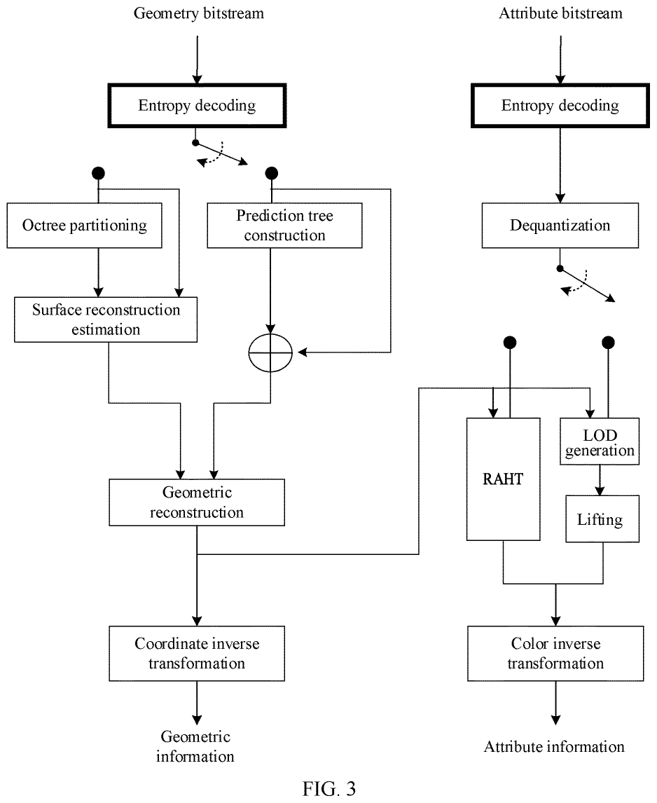

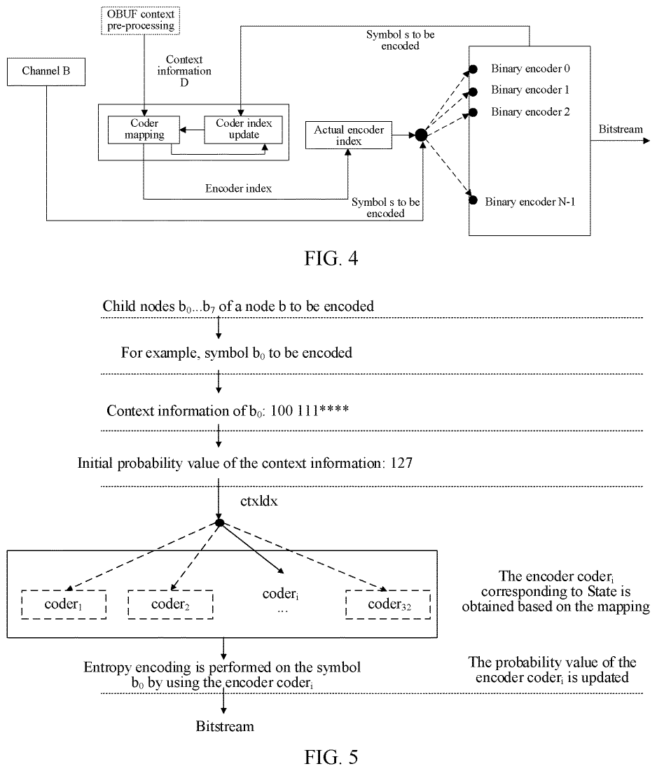

FIG. 4 is a schematic diagram of an implementation process of the OBUF technology. As shown in FIG. 4, encoder index values obtained after mapping are [0, 1, . . . , N−1] and the symbol s is an occupancy bit to be encoded or decoded, with a value of 1 or 0.

1) the OBUF Technology May be Divided into the Following Three Steps:

### (1) Obtain Context Information D of a Symbol to be Encoded

The context information D of the symbol to be encoded is input information of the OBUF that includes information of already encoded neighbor nodes in space and a position of a child node relative to a parent node.

### (2) Obtain a Binary Encoder Index i Corresponding to the Context Information D Based on a Mapping Relationship

Before all symbols to be encoded are encoded, each state is mapped to a respective one of N encoders through a lookup table. For example, each piece of context information D is mapped to a respective one of 32 encoders (that is, a value of i is [0, 1, . . . , 31]), such as the binary entropy encoder i in FIG. 4.

### (3) Perform Entropy Encoding on the Symbol S by Using the Binary Encoder i

The symbol S to be encoded is input into the binary encoder corresponding to its context information D for entropy encoding.

### 2) Examples of Applying the OBUF Technology

As shown in FIG. 5, assuming that an occupancy state b0 of a child node 0 among eight child nodes of a current node is encoded, where a value of b0 is 0 or 1, 0 indicates being unoccupied and 1 indicates being occupied. First, context information (State) of the child node b0 to be encoded is determined, that is, occupancy states of already encoded nodes are determined, which is derived from already encoded neighbor nodes of the current child node to be encoded, a parent node thereof, and neighbor nodes thereof. These nodes are called context nodes. Each context node has two states: occupied and unoccupied. Occupancy states of all the context nodes constitute the context information. Then, a binary encoder coderi corresponding to the context information (State) is obtained based on the mapping relationship. Finally, entropy encoding is performed on the to-be-encoded symbol b0 by using the binary encoder coderi.

### 2. Dynamic OBUF Technology

Compared to the OBUF technology, in the dynamic OBUF technology, a fixed quantity of contexts is no longer used, and the quantity of contexts is dynamically adjusted during the encoding process.

The dynamic OBUF technology has two stages: 1) dynamically determining context nodes and context information; 2) mapping the context information to a smaller quantity of binary encoder groups (corresponding to the OBUF technology).

The following describes context construction and dynamic adjustment. In the dynamic OBUF technology, context information is divided into two parts: primary information and secondary information. Whether part of the secondary information is used as context information is dynamically adjusted, and context information composed of the primary information and selected secondary information is used as context information in OBUF.

### 1) Context Information Construction Process:

Context nodes of the child node to be encoded include the following categories:
(1) an already encoded sibling node;
(2) six face-sharing parent neighbor nodes of the current node; and
(3) Other 20 edge-sharing or vertex-sharing parent neighbor nodes of the current node.

It should be noted that, scanning order of these context nodes from front to back is: an encoded sibling node of the current child node>an encoded face-sharing child node neighbor of the current child node>an encoded edge-sharing child node neighbor of the current child node>an encoded vertex-sharing child node neighbor of the current child node>other encoded child node neighbors of the current child node>an encoded face-sharing parent node neighbor of the current child node>an encoded edge-sharing parent node neighbor of the current child node>other twenty encoded parent node neighbors. According to the scanning order, context information is constructed for the child node to be encoded. The first N bits of the context information are primary information, and the last M bits are secondary information. M is dynamically adjusted during the encoding process.

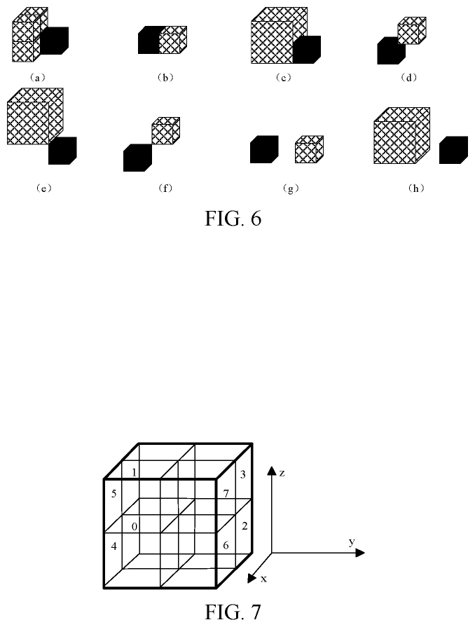

FIG. 6 is a schematic diagram illustrating dynamic adjustment of context priorities. As shown in FIG. 6, the black-filled child node is the current child node. Eight cases are provided herein: the grid-filled child nodes in part (a) are sibling child nodes of the current child node; the grid-filled child node in part (b) is a face-sharing neighboring child node of the current child node; the grid-filled child node in part (c) is a face-sharing neighboring parent node of the current child node; the grid-filled child node in part (d) is an edge-sharing neighboring child node of the current child node; the grid-filled child node in part (e) is a neighboring parent node adjacent to the current child node; the grid-filled child node in part (f) is a vertex-sharing neighboring child node of the current child node; the grid-filled child node in part (g) is a child neighbor node non-adjacent to the current child node; and the grid-filled child node in part (h) is a parent neighbor node non-adjacent to the current child node.

It should be further noted that, during context information construction, different context models may be first constructed, according to a preset scanning order, for to-be-encoded child nodes located at different positions in the current node. For example, FIG. 7 is a schematic diagram of scanning order of child nodes in a current node. The scanning order is child node 0, child node 1, child node 2, child node 3, child node 4, child node 5, child node 6, and child node 7 in FIG. 7, and may be used to sequentially construct different context models. In addition, as a quantity of encoded child nodes in the current node increases, valid context information that may be referenced by a non-encoded child node also changes. Moreover, there are different manners of determining local sparsity of the eight child nodes of the current node, so that each child node has its own context bins.

### 2) Dynamic Adjustment Process

Each context node may be unoccupied or occupied, that is, in a state of 0 or 1. The context information may be represented by N+M binary bits, where the N bits correspond to primary information and the M bits correspond to secondary information. During the encoding process, a quantity of times each piece of context information is used is recorded. When a quantity of times a specific piece of context information is used is greater than a threshold T, a context node is added according to scanning order, that is, the context information is subdivided by introducing a new context node. Subsequent child nodes to be encoded are encoded using the updated context information set.

### 3. G-PCC Dense Point Cloud Inter-Frame Encoding

### 1) Octree Geometry Encoding

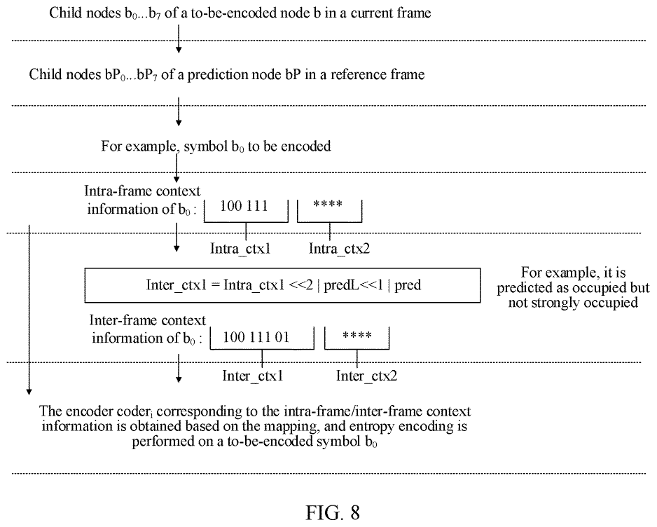

In G-PCC, both intra-frame and inter-frame encoding of octree geometric information are performed using the OBUF technology for entropy encoding. However, a context construction method in inter-frame encoding differs from that in intra-frame encoding. Specifically, inter-frame context information (Inter State) is actually a combination of intra-frame context information (Intra State) of the current symbol to be encoded and prediction information of the current node to be encoded that is obtained through a reference frame. A specific method is to add information that indicates whether the current node is in an occupancy state or strong occupancy state and that is obtained through the reference frame into intra-frame context information, for example, to intra-frame context primary information (Intra_ctx1), that is, Inter_ctx1=Intra_ctx1<<2|predL<<1|pred. Herein, predL indicates whether the current child node is predicted to be strongly occupied, and pred indicates whether the current child node is predicted to be occupied. FIG. 8 is a schematic diagram of a process of constructing inter-frame context information.

### 2. Octree Geometry Encoding Based on Inter Prediction

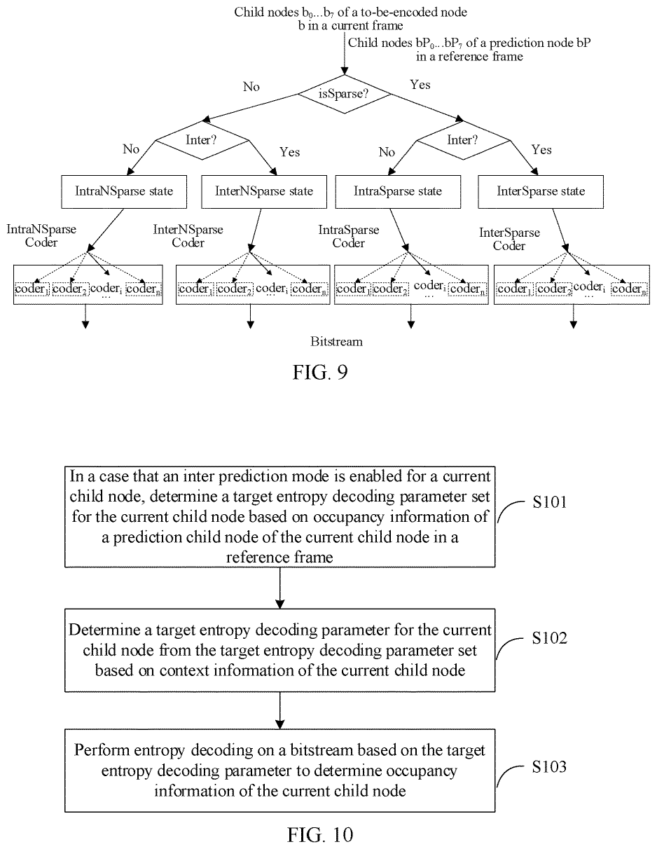

FIG. 9 is a schematic diagram of intra-frame and inter-frame entropy encoding processes based on the OBUF technology. First, a value of isSparse is determined based on intra-frame context information (Intra state) of the child node to be encoded. Here, “isSparse” refers to local sparsity of the child node to be encoded, which is determined based on an occupancy state of an already encoded neighbor node of the child node to be encoded. According to the value (0 or 1) of isSparse, context states are classified into a sparse context state set and a non-sparse context state set.

Second, a value of isInter2 is determined based on an inter-frame enable flag and an occupancy state of the prediction node. Based on the value (0 or 1) of isInter2, the context states further divided into an intra-frame context state set and an inter-frame context state set. In other words, based on the values of isSparse and isInter2, context states are divided into four sets, including an intra-frame non-sparse context state (IntraNSparse state) set, an inter-frame non-sparse context state (InterNSparse state) set, an intra-frame sparse context state (IntraSparse state) set, and an inter-frame sparse context state (InterSparse state) set.

Then, based on encoder groups (IntraNSparse Coder, InterNSparse Coder, IntraSparse Coder, InterSparse Coder) corresponding to respective sets, a current context state is mapped to a binary encoder. Finally, the encoder coderi is obtained based on the mapping, and entropy encoding is performed on the symbol b0 to be encoded.

In the above technology, entropy encoding is performed on the inter-frame sparse context and the inter-frame non-sparse context using their respective encoder groups, ignoring a correlation between the inter-frame sparse context and the inter-frame non-sparse context, which may affect encoding efficiency to some extent.

Based on this, an embodiment of this application provides an encoding method and a decoding method. During octree geometry encoding with inter prediction, the best entropy encoding/decoder parameter set is selected for the current child node by fully utilizing inter prediction information, and the best entropy encoding/decoder parameter is further determined from the selected entropy encoding/decoder parameter set based on the context information. When encoding and decoding are performed using the best entropy encoding/decoder parameter, a bit rate is effectively reduced, and the encoding and decoding efficiency is improved.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least part of the following content.

In an embodiment of this application, referring to FIG. 10, FIG. 10 is a schematic flowchart of a decoding method according to this embodiment of this application. As shown in FIG. 10, the method may include the following steps.

In S101, in a case that an inter prediction mode is enabled for a current child node, a target entropy decoding parameter set for the current child node is determined based on occupancy information of a prediction child node of the current child node in a reference frame.

It should be noted that, the current child node is any one of child nodes within a current node to be decoded. As shown in FIG. 7, the current node includes eight child nodes, and scanning order of the child nodes is the child node 0, child node 1, child node 2, child node 3, child node 4, child node 5, child node 6, and child node 7.

The prediction child node is a co-located child node of the current child node in a prediction node. The prediction node is a prediction node of the current node in the reference frame. Prediction information of the current node is determined based on occupancy information of the prediction node. The prediction node includes a plurality of prediction child nodes. Further, prediction information of the current child node may be determined based on occupancy information of the co-located prediction child node of the current child node. The occupancy information, also called position occupancy information or occupancy symbol. A value of the occupancy information is 0 or 1, where 0 indicates being unoccupied and 1 indicates being occupied.

The target entropy decoding parameter set includes a plurality of entropy decoding parameters. An entropy decoding parameter is any parameter used for performing entropy decoding on occupancy information of a child node. In some embodiments, the entropy decoding parameter may be an arithmetic decoding parameter, and adaptive arithmetic decoding is performed on occupancy information of a child node based on the arithmetic decoding parameter. For example, the arithmetic decoding parameter may be a probability that the current child node is occupied or unoccupied under any context information.

In some embodiments, the target entropy decoding parameter set for the current child node is determined from a plurality of entropy decoding parameter sets based on occupancy information of the prediction child node of the current child node in the reference frame. In other words, different entropy decoding parameter sets may be configured in advance for different inter prediction situations to improve inter prediction accuracy. When the inter prediction mode is enabled, a matched target entropy decoding parameter set is selected based on an actual inter prediction situation.

In some embodiments, the method further includes: determining, based on a value of a first syntax element, whether the inter prediction mode is allowed to be enabled for a current node; in a case that the inter prediction mode is allowed to be enabled for the current node, determining occupancy information of a prediction node of the current node in the reference frame; and determining whether the inter prediction mode is enabled for a child node of the current node based on the occupancy information of the prediction node, where the current child node is any one of child nodes within the current node.

Whether the inter prediction mode is enabled for the current child node is related to the value of the first syntax element and occupancy information of a prediction node of its parent node. The first syntax element, as an enable flag for inter prediction, is used to indicate whether upper-layer inter prediction is enabled. In some embodiments, in a case that the value of the first syntax element is a first numerical value, it is determined that the inter prediction mode is allowed to be enabled for the current node; and in a case that the value of the first syntax element is a second numerical value, it is determined that the inter prediction mode is not allowed to be enabled for the current node. For example, the first syntax element identifier includes at least a frame-level syntax element, where the value of 1 for the first syntax element indicates that inter prediction is allowed to be enabled, and a value of 0 for the first syntax element indicates that inter prediction is not allowed to be enabled.

In some embodiments, in a case that the occupancy information of the prediction node indicates being occupied, it is determined that the inter prediction mode is enabled for the current node; and in a case that the occupancy information of the prediction node indicates being unoccupied, it is determined that an intra prediction mode is enabled for the current node. For example, a value of 0 for the occupancy information indicates being unoccupied, and a value of 1 indicates being occupied. In other words, when the prediction node is occupied, inter prediction is enabled for the current node, so that prediction accuracy is improved by fully utilizing the inter prediction information. Otherwise, inter prediction is not enabled.

An occupancy state of the prediction node is related to an occupancy state of its child node. In some embodiments, the method further includes: determining occupancy information of a plurality of prediction child nodes in the prediction node; in a case that occupancy information of at least one prediction child node in the prediction node indicates being occupied, determining that the occupancy information of the prediction node indicates being occupied; and otherwise, determining that the occupancy information of the prediction node indicates being unoccupied. In other words, if at least one child node in the prediction node is occupied, the value of its occupancy information is set to 1. Conversely, if no child node is occupied, the value of its occupancy information is set to 0.

In some embodiments, the determining the target entropy decoding parameter set for the current child node based on the occupancy information of the prediction child node of the current child node in the reference frame includes: in a case that the occupancy information of the prediction child node indicates being unoccupied, determining that the target entropy decoding parameter set is a first entropy decoding parameter set; and in a case that the occupancy information of the prediction child node indicates being occupied, determining that the target entropy decoding parameter set is a second entropy decoding parameter set. In other words, an entropy decoding parameter set is assigned to the current child node based on an occupancy state of the prediction child node, where the first entropy decoding parameter set includes a plurality of entropy decoding parameters for the current child node when the prediction child node is unoccupied, and the second entropy decoding parameter set includes a plurality of entropy decoding parameters for the current child node when the prediction child node is occupied.

Further, when the occupancy information of the prediction child node indicates being occupied, the method further includes: determining occupancy strength of the prediction child node based on a quantity of occupied nodes in the prediction child node; and determining the second entropy decoding parameter set based on the occupancy strength. In other words, in a case that the prediction child node is occupied, the occupancy strength may be further divided into two or more occupancy strengths based on a quantity of occupied nodes in the prediction child node, thereby matching an appropriate entropy decoding parameter set based on the occupancy strength, and further improving prediction accuracy of the current child node.

In some embodiments, the determining the occupancy strength of the prediction child node based on the quantity of occupied nodes in the prediction child node includes: in a case that the quantity of occupied nodes in the prediction child node is greater than a first threshold, determining that the occupancy strength is strong occupancy; and in a case that the quantity of occupied nodes in the prediction child node is less than or equal to the first threshold, determining that the occupancy strength is occupancy.

For example, when the occupancy information of the prediction child node indicates being unoccupied, it is determined that the target entropy decoding parameter set is the first entropy decoding parameter set. When the occupancy information of the prediction child node indicates being occupied and the occupancy strength is strong occupancy, it is determined that the second entropy decoding parameter set is a strong occupancy entropy decoding parameter set. When the occupancy information of the prediction child node indicates being occupied and the occupancy strength is occupancy (also referred to as weak occupancy), it is determined that the second entropy decoding parameter set is an occupancy entropy decoding parameter set.

In S102, a target entropy decoding parameter for the current child node is determined from the target entropy decoding parameter set based on context information of the current child node.

The context information is related to occupancy information of a context node of the current child node. In some embodiments, the context information is constructed based on the occupancy information of the context node of the current child node and a target construction strategy.

In some embodiments, the target construction strategy includes: constructing the context information based on a preset context node scanning order and the occupancy information of the context node.

For example, the context node includes at least one of the following: a decoded sibling node of the current child node; a decoded neighboring child node sharing a face, an edge, or a vertex with the current child node; a decoded neighboring parent node sharing a face or an edge with the current child node; or another decoded neighbor node of the current child node. Scanning order of the context nodes may be: a decoded sibling node of the current child node>a decoded face-sharing child node neighbor of the current child node>a decoded edge-sharing child node neighbor of the current child node>a decoded vertex-sharing child node neighbor of the current child node>other decoded child node neighbors of the current child node>a decoded face-sharing parent node neighbor of the current child node>a decoded edge-sharing parent node neighbor of the current child node>other twenty decoded parent node neighbors. Context information is constructed for the to-be-decoded child node based on the scanning order and occupancy information.

In some other embodiments, the target construction strategy includes: constructing first information and second information in the context information based on a preset context information composition structure and the occupancy information of the context node, where a quantity of bits of the first information is fixed, and a quantity of bits of the second information is adjustable. Herein, the first information may be primary information, the second information may be secondary information, and whether part of the secondary information is used as context information is dynamically adjusted.

In some embodiments, the determining the target entropy decoding parameter for the current child node from the target entropy decoding parameter set based on the context information of the current child node includes: determining a context state of the current child node from a target context state set of the current child node based on the context information of the current child node, where the target context state set includes mapping relationships between a plurality of types of context information and context states; and determining the target entropy decoding parameter for the current child node from the target entropy decoding parameter set based on the context state of the current child node. Here, one or more types of context information correspond to one context state, and the context state is used to index a corresponding target entropy decoding parameter.

The target context state set includes mapping relationships between a plurality of types of context information and context states. For example, when the context information has 19 bits, there are at most 2¹⁹ states. When the context information has 16 bits, there are at most 2¹⁶ states. The target context state set is indexed according to the context information of the current child node, so as to determine the context state of the current child node. Further, the target entropy decoding parameter set is indexed according to the context state, so as to determine the target entropy decoding parameter for the current child node.

In some embodiments, the method may further include: determining a local sparsity category of the current child node based on occupancy information of decoded neighbor nodes of the current child node; and determining the target context state set of the current child node based on the local sparsity category.

The local sparsity category is used to indicate local sparsity of decoded neighbor nodes of the current child node. A plurality of context state sets may be pre-configured, with different local sparsity categories corresponding to different context state sets. In some embodiments, the determining the local sparsity category of the current child node based on the occupancy information of decoded neighbor nodes of the current child node includes: determining an occupancy quantity of the neighbor nodes based on the occupancy information of the neighbor nodes; and in a case that the occupancy quantity of the neighbor nodes is greater than a second threshold, determining that the local sparsity category of the current child node is a first category; or in a case that the occupancy quantity of the neighbor nodes is less than or equal to a second threshold, determining that the local sparsity category of the current child node is a second category.

In other words, the occupancy quantity (NN) of the neighbor nodes can be determined based on the occupancy information of the neighbor nodes (that is, whether they are occupied). Then, the local sparsity category of the current child node can be determined based on a result of comparison between the NN and the second threshold. The first category may be a non-sparse category, and the second category may be a sparse category.

The decoded neighbor nodes of the current child node may be the same or not completely the same as decoded context nodes of the current child node. For example, the neighbor node includes at least one of the following: a decoded sibling node of the current child node; a decoded neighboring child node adjacent to the current child node in a first preset direction; a decoded neighboring child node adjacent to the current child node in a second preset direction; or a decoded neighboring child node adjacent to the current child node in a third preset direction. The first preset direction may refer to a negative x-axis direction (left side Left direction) of the current child node, the second preset direction may refer to a negative y-axis direction (front side Front direction) of the current child node, and the third preset direction may refer to a negative z-axis direction (bottom side Bottom direction) of the current child node.

For example, local sparsity (isSparse) of the symbol bn to be decoded is determined based on an occupancy state of the decoded neighbor nodes. A local sparsity category of the child node 0 may be determined based on an occupancy quantity (NN) of 12 decoded child nodes adjacent to the current child node in the negative x-axis, y-axis, z-axis directions in in FIG. 11, where the occupancy quantity NN>1 indicates being non-sparse (isSparse is 0), and the occupancy quantity NN≤1 indicates being sparse (isSparse is 1). A local sparsity category of the child node 1 may be determined based on an occupancy quantity (NN) of four decoded child nodes adjacent to the current child node in the negative y-axis direction (Front) in FIG. 11, where the occupancy quantity NN>0 indicates being the non-sparse category, and the occupancy quantity NN=0 indicates being the sparse category. A local sparsity category of the child node 2 may be determined based on an occupancy quantity (NN) of four decoded child nodes adjacent to the current child node in the negative z-axis direction (Bottom) in FIG. 11, where the occupancy quantity NN>0 indicates being the non-sparse category, and the occupancy quantity NN=0 indicates being the sparse category. A local sparsity category of the child node 3 may be determined based on an NN of seven nodes including three nodes bit0+bit1+bit2 and four decoded nodes adjacent to the current child node in the negative x-axis direction (Left) in FIG. 11, where the occupancy quantity NN>1 indicates being the non-sparse category, and the occupancy quantity NN≤1 indicates being the sparse category.

In some embodiments, the determining the target context state set of the current child node based on the local sparsity category includes: in a case that the local sparsity category is a first category, determining that the target context state set is a first context state set; and in a case that the local sparsity category is a second category, determining that the target context state set is a second context state set.

In some embodiments, the determining the target context state set of the current child node based on the local sparsity category includes: in a case that the inter prediction mode is enabled for the current child node, determining the target context state set of the current child node from an inter-frame context state set based on the local sparsity category; and in a case that an intra prediction mode is enabled for the current child node, determining the target context state set of the current child node from an intra-frame context state set based on the local sparsity category.

In embodiments of this application, the target context state set to be used is determined based on the local sparsity category and whether inter prediction is enabled. When the category is the non-sparse category and inter prediction is not used, an intra-frame non-sparse context state set (IntraNSparse state) is used. When the category is the sparse category and inter prediction is not used, an intra-frame sparse context state set (IntraSparse state) is used. When the category is the non-sparse category and inter prediction is used, an inter-frame non-sparse context state set (InterNSparse state) is used. When the category is the sparse category and inter prediction is used, an inter-frame sparse context state set (InterSparse state) is used.

In some embodiments, the method further includes: constructing a plurality of types of context information in the intra-frame context state set based on occupancy information of a context node and a first construction strategy, and initializing a context state for each type of context information; and constructing a plurality of types of context information in the inter-frame context state set based on occupancy information of a context node and a second construction strategy, and initializing a context state for each type of context information.

In embodiments of this application, the first construction strategy may include: constructing the context information based on a preset context node scanning order and the occupancy information of the context node; or constructing first information and second information in the context information based on a preset context information composition structure and the occupancy information of the context node, where a quantity of bits of the first information is fixed, and a quantity of bits of the second information is adjustable. The second construction strategy may include: constructing the context information based on a preset context node scanning order and the occupancy information of the context node; or constructing first information and second information in the context information based on a preset context information composition structure and the occupancy information of the context node, where a quantity of bits of the first information is fixed, and a quantity of bits of the second information is adjustable. The first construction strategy is the same as or different from the second construction strategy.

In some embodiments, the method further includes: in a case that an intra prediction mode is enabled for the current child node, determining the target entropy decoding parameter set for the current child node based on the local sparsity category. For example, in a case that the local sparsity category is the first category, it is determined that the target entropy decoding parameter set is a third entropy decoding parameter set; and in a case that the local sparsity category is the second category, it is determined that the target entropy decoding parameter set is a fourth entropy decoding parameter set. In other words, the intra prediction mode is enabled for the current child node, an entropy decoding parameter set is assigned based on the local sparsity category of the current child node, the third entropy decoding parameter set may include a plurality of entropy decoding parameters corresponding to the local non-sparse category, and the fourth entropy decoding parameter set may include a plurality of entropy decoding parameters corresponding to the local sparse category.

In some embodiments, the determining the target entropy decoding parameter for the current child node from the target entropy decoding parameter set based on the context state of the current child node includes: determining an index value of the target entropy decoding parameter based on the context state; and determining the target entropy decoding parameter for the current child node from the target entropy decoding parameter set based on the index value of the target entropy decoding parameter. In other words, in the target entropy decoding parameter set, according to a specific mapping rule, the context state is mapped to an index value of an entropy decoding parameter to index the target entropy decoding parameter.

In embodiments of this application, the entropy decoding parameter may include a probability of the current child node being occupied or unoccupied under the context information. In some embodiments, the context state may be an initial probability of the current child node being occupied (or unoccupied) under a current context situation. A large quantity of context states are mapped to a fixed quantity of probability models/context models, and arithmetic decoding is performed on the occupancy information of the current child node by using an indexed probability model, thereby improving decoding efficiency.

In some embodiments, the determining the index value of the target entropy decoding parameter based on the context state includes: determining the index value of the target entropy decoding parameter based on the most significant M bits of the context state, where M is related to a quantity of parameters in the target entropy decoding parameter set. For example, when the quantity N of parameters in the target entropy decoding parameter set is 32, the most significant five bits of the context state are used, and a value thereof serves as an index value of the target entropy decoding parameter.

In embodiments of this application, a method for constructing inter-frame context information may be the same as a method for constructing intra-frame context information. For example, a solution for constructing an intra-frame context may be as follows:
(1) The child node 0 has a face-sharing child node neighbor, an edge-sharing child node neighbor, and a vertex-sharing child node neighbor, has no decoded sibling node, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 16 bits, with a maximum of 2¹⁶ states. The most significant 4 bits are used as primary information and the least significant 12 bits as non-reduced secondary information.

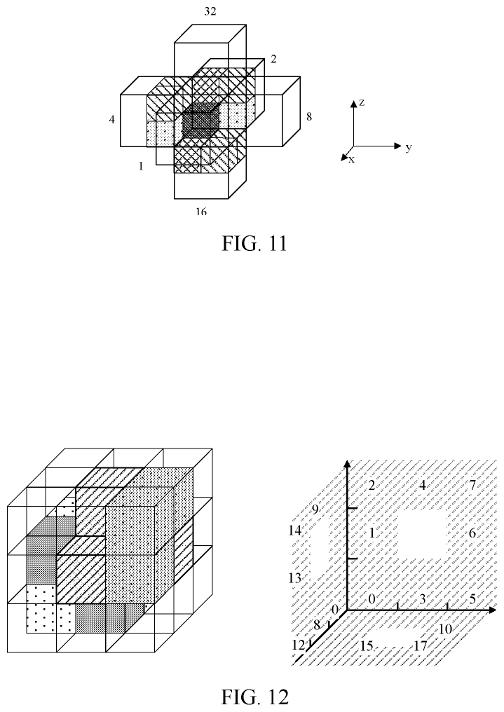

Local sparsity of the child node 0 may be determined based on an occupancy quantity (NN) of twelve decoded child nodes adjacent to the current child node in the negative x-axis, y-axis, and z-axis directions in FIG. 11, where the occupancy quantity NN>1 indicates being the non-sparse category, and the occupancy quantity NN<1 indicates being the sparse category. For example, FIG. 11 is a schematic diagram showing distribution of child neighbor nodes and face-sharing parent neighbor nodes of the child node 0, and FIG. 12 is a schematic diagram showing a distribution sequence of 20 parent neighbor nodes of the child node 0. Numbers such as 1, 2, 4, 8, 16, and 32 indicate serial numbers of the neighbor nodes.

Herein, Table 1 shows explanation of context information of each bit corresponding to the child node 0, and an order from the most significant bit to the least significant bit reflects important of information. 1 or 0 filled with black indicates a flag bit for a current category. For example, three directions indicate that an occupied context node exists in each of the negative x-axis, y-axis, and z-axis directions, two directions indicate that an occupied context node exists in each of two directions among the negative x-axis, y-axis, and z-axis directions, and one direction indicates that an occupied context node exists in one of the negative x-axis, y-axis, and z-axis directions. The NOT operation “!” indicates that the bit symbol is information obtained by inverting its actual symbol. In addition, face-sharing child nodes, edge-sharing child nodes, vertex-sharing child nodes, edge-related child nodes, co-located child nodes, and the like. In Table 1, meanings of symbols are respectively explained as follows: B (Bottom), F (Front), and L (left) are parent neighbors numbered 16, 4, and 2 among the six face-sharing neighbors of the current node in FIG. 11. Since the three decoded nodes are located in the negative coordinate-axis directions of the current node, occupancy information of child nodes thereof can be obtained. Therefore, Table 1 lists, bit by bit, face-sharing child nodes, edge-sharing child nodes, and vertex-sharing child nodes of the current child node in the three directions. It should be noted that, for example, English abbreviations B, F, and L indicate face-sharing child nodes, edge-sharing child nodes, and vertex-sharing child nodes of the current child node. For example, English full names Bottom, Front, and Left indicate face-sharing parent neighbors, edge-sharing parent neighbors, and vertex-sharing parent neighbors of the current child node. Top, Back, and Right are parent neighbors numbered 32, 8, and 1 among six face-sharing neighbors of the current node in FIG. 11. Because the three decoded nodes are located in the positive coordinate-axis directions of the current node, occupancy information of child nodes thereof cannot be obtained, and their correlation with the current child node is weaker than that of the foregoing 12 child neighbor nodes. Other numbers such as 9, 4, 1, and 2 in Table 1 are sequence numbers of 20 edge-sharing/vertex-sharing neighbors of the current node except the six face-sharing parent neighbors shown in FIG. 12. The co-located child nodes _{bit0}B, _{bit0}F, and _{bit0}L in Table 1 may be understood as follows: a child node whose number is 0 also exists in each of the decoded nodes Bottom, Front, and Left, and this node is referred to as a co-located child node. In Table 1, LF, LB, and FB represented by two letters denote occupancy information (obtained based on occupancy code of a neighbor numbered 1 in the 20 neighbors) of two edge-sharing child nodes of the current child node that are located between the Left and Front directions; occupancy information (obtained based on occupancy code of a neighbor numbered 8 in the 20 neighbors) of two edge-sharing child nodes of the current child node that are located between the Left and Bottom directions; and occupancy information (obtained based on occupancy code of a neighbor numbered 3 in the 20 neighbors) of two edge-sharing child nodes of the current child node that are located between the Front and Bottom directions.
(2) The child node 1 has a face-sharing child node neighbor, an edge-sharing child node neighbor, and a vertex-sharing child node neighbor, has one decoded sibling node bit0, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 19 bits, with a maximum of 2¹⁹ states. The most significant 7 bits are used as primary information and the least significant 12 bits as non-reduced secondary information.

Local sparsity of the child node 1 may be determined based on an occupancy quantity (NN) of four decoded child nodes adjacent to the current child node in the negative y-axis direction (Front) in FIG. 11, where the occupancy quantity NN>0 indicates being the non-sparse category, and the occupancy quantity NN=0 indicates being the sparse category. Herein, Table 2 shows explanation of context information of each bit in the bins, and it can be learned that a decoded sibling node 0 occupies most important information and is located at a most significant bit of the bins.
(3) The child node 2 has a face-sharing child node neighbor, an edge-sharing child node neighbor, and a vertex-sharing child node neighbor, has two decoded sibling nodes bit0 and bit1, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 19 bits, with a maximum of 2¹⁹ states. The most significant 7 bits are used as primary information and the least significant 12 bits as non-reduced secondary information.

Local sparsity of the child node 2 may be determined based on an occupancy quantity (NN) of four decoded child nodes adjacent to the current child node in the negative z-axis direction (Bottom) in FIG. 11, where the occupancy quantity NN>0 indicates being the non-sparse category, and the occupancy quantity NN=0 indicates being the sparse category. Herein, Table 3 shows explanation of context information of each bit in the bins, and it can be learned that a decoded sibling node 0 occupies most important information and is located at a most significant bit of the bins.
(4) The child node 3 has a face-sharing child node neighbor, an edge-sharing child node neighbor, and a vertex-sharing child node neighbor, has three decoded sibling nodes bit0, bit1, and bit2, and has a face-sharing parent node neighbor and 20 other decoded neighbors that may be referenced. When it is determined to be the non-sparse category, the context bins include 17 bits, with a maximum of 2¹⁷ states. The most significant 6 bits are used as primary information and the least significant 11 bits as non-reduced secondary information. When it is determined to be the sparse category, the context bins include 18 bits, with a maximum of 2¹⁸ states. The most significant 6 bits are used as primary information and the least significant 12 bits as non-reduced secondary information.

Local sparsity of the child node 3 may be determined based on an NN of seven nodes including three nodes bit0+bit1+bit2 and four decoded nodes adjacent to the current child node in the negative x-axis direction (Left) in FIG. 11, where the occupancy quantity NN>1 indicates being the non-sparse category, and the occupancy quantity NN≤1 indicates being the sparse category.
(5) The child node 4 has a face-sharing child node neighbor, an edge-sharing child node neighbor, and a vertex-sharing child node neighbor, has four decoded sibling nodes bit0, bit1, bit2, and bit3, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 16 bits, with a maximum of 2¹⁶ states. The most significant 4 bits are used as primary information and the least significant 12 bits as non-reduced secondary information.

Local sparsity of the child node 4 may be determined based on an NN of twelve nodes including four nodes bit0+bit1+bit2+bit3 (denoted as “new Left”), four decoded nodes adjacent to the current child node in the negative y-axis direction (Front) in FIG. 11, and four decoded nodes adjacent to the current child node in the negative z-axis direction (Bottom) in FIG. 11, where the occupancy quantity NN>1 indicates being the non-sparse category, and the occupancy quantity NN≤1 indicates being the sparse category.
(5) The child node 5 has a face-sharing child node neighbor, an edge-sharing child node neighbor, and a vertex-sharing child node neighbor, has five decoded sibling nodes bit0, bit1, bit2, bit3, and bit4, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 19 bits, with a maximum of 2¹⁹ states. The most significant 7 bits are used as primary information and the least significant 12 bits as non-reduced secondary information.

Local sparsity of the child node 5 may be determined based on an NN of child nodes adjacent to the current child node in the negative y-axis direction (Front) in FIG. 11, where the occupancy quantity NN>0 indicates being the non-sparse category, and the occupancy quantity NN=0 indicates being the sparse category.
(7) The child node 6 has a face-sharing child node neighbor, an edge-sharing child node neighbor, and a vertex-sharing child node neighbor, has six decoded sibling nodes bit0, bit1, bit2, bit3, bit4, and bit5, and has a face-sharing parent node neighbor and 20 other decoded neighbors that may be referenced. When it is determined to be the non-sparse category, the context bins include 19 bits, with a maximum of 2¹⁹ states. The most significant 6 bits are used as primary information and the least significant 13 bits as non-reduced secondary information. When it is determined to be the sparse category, the context bins include 19 bits, with a maximum of 2¹⁹ states. The most significant 7 bits are used as primary information and the least significant 12 bits as non-reduced secondary information.

Local sparsity of the child node 6 may be determined based on an NN of child nodes adjacent to the current child node in the negative z-axis direction (Bottom) in FIG. 11, where the occupancy quantity NN>0 indicates being the non-sparse category, and the occupancy quantity NN=0 indicates being the sparse category.
(8) The child node 7 has no face-sharing child node neighbor, edge-sharing child node neighbor, or vertex-sharing child node neighbor, has seven decoded sibling nodes bit0, bit1, bit2, bit3, bit4, bit5, and bit6, and has a face-sharing parent node neighbor and 20 other decoded neighbors that may be referenced. When it is determined to be the non-sparse category, the context bins include 17 bits, with a maximum of 2¹⁷ states. The most significant 6 bits are used as primary information and the least significant 11 bits as non-reduced secondary information. When it is determined to be the sparse category, the context bins include 18 bits, with a maximum of 2¹⁸ states. The most significant 6 bits are used as primary information and the least significant 12 bits as non-reduced secondary information.

Local sparsity of the child node 7 may be determined based on an NN of seven nodes including bit0+bit1+bit2+bit3+bit4+bit5+bit6, where the occupancy quantity NN>1 indicates being the non-sparse category, and the occupancy quantity NN≤1 indicates being the sparse category.

In S103, entropy decoding is performed on a bitstream based on the target entropy decoding parameter to determine occupancy information of the current child node.

In some embodiments, the method further includes: updating the target entropy decoding parameter based on the occupancy information of the current child node.

In some embodiments, the method further includes: updating the context state based on the occupancy information of the current child node.

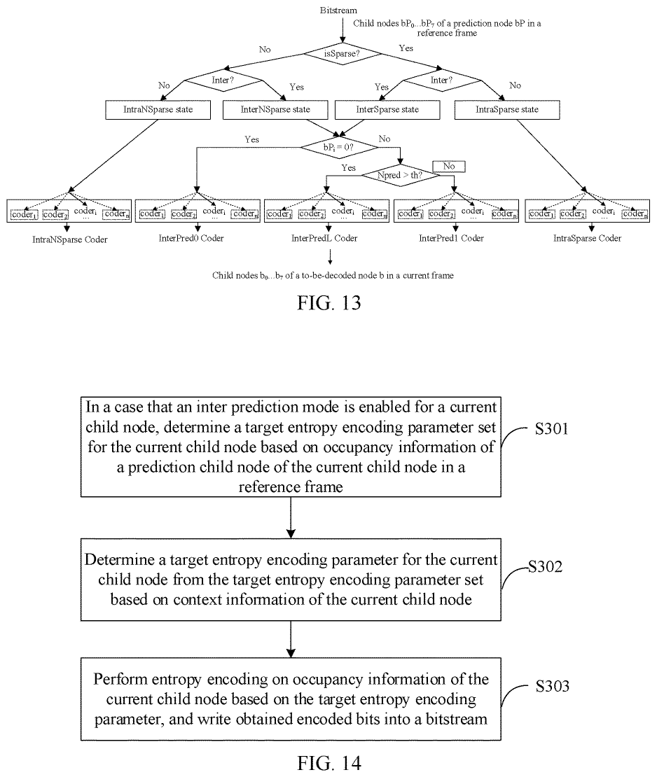

On the basis of the foregoing embodiments, the decoding method provided in embodiments of this application is further described by using examples. As shown in FIG. 13, the decoding method is specifically a decoding method for point cloud geometric information, and the method may include the following steps.

In S201, local sparsity is determined.

The local sparsity (isSparse) of the symbol bn to be decoded is determined based on the occupancy information of the decoded neighbor nodes. For example, local sparsity of the child node 0 is determined based on an occupancy quantity (NN) of 12 decoded child nodes adjacent to the current child node in the negative x-axis, y-axis, and z-axis directions, where the occupancy quantity NN>1 indicates being non-sparse (isSparse is 0), and the occupancy quantity NN≤1 indicates being sparse (isSparse is 1).

According to the value (0 or 1) of isSparse, context states may be classified into a sparse context state set and a non-sparse context state set.

In S202, whether to enable inter prediction is determined.

Whether to enable inter prediction is determined based on the occupancy information (predOcc) of the prediction node of the current node in the reference frame and the enable flag (isInter) for inter prediction, that is, a value of isInter2 is determined.

isInter2=isInter && predOcc, where the value of isInter2 is determined by isInter and predOcc, and predOcc is a flag used to indicate whether the prediction node is occupied. Specifically, if at least one child node bPi in the prediction node is occupied, predOcc is set to 1. Otherwise, if no child nodes are occupied, predOcc is 0. In addition, the value of isInter is controlled by a syntax element gbh.interPredictionEnabledFlag, and the syntax element is used to indicate whether upper-layer inter prediction is enabled. If inter prediction is enabled, the frame is referred to as a P-frame, and in this case, isInter is 1. Otherwise, if inter prediction is not enabled, the frame is referred to as an I-frame, and isInter is 0.

In S203, context state selection is performed.

First, a context state set to be used is determined based on the sparsity flag (isSparse) and the inter prediction flag (isInter2). When the category is the non-sparse category and inter prediction is not used, an intra-frame non-sparse context state set (IntraNSparse state) is used. When the category is the sparse category and inter prediction is not used, an intra-frame sparse context state set (IntraSparse state) is used. When the category is the non-sparse category and inter prediction is used, an inter-frame non-sparse context state set (InterNSparse state) is used. When the category is the sparse category and inter prediction is used, an inter-frame sparse context state set (InterSparse state) is used. A method for constructing the context information in the intra-frame non-sparse context state set (IntraNSparse state), the intra-frame sparse context state set (IntraSparse state), the inter-frame non-sparse context state set (InterNSparse state), and the inter-frame sparse context state set (InterSparse state) may be the construction method in OBUF, or the construction method in dynamic OBUF, and a method for constructing the context on the decoding side is the same as that on the encoding side.

It should be noted that, compared to a method for constructing inter-frame context information in the prior art, two bits of inter prediction information is added to intra-frame context information, and a quantity of inter-frame context states is four times that of intra-frame context states, thereby requiring a large amount of storage space. The inter-frame context construction method in the embodiments of this application may be the same as the intra-frame context construction method, without using inter prediction information for construction, thereby reducing a quantity of inter-frame context states, saving storage space, and improving decoding efficiency.

Second, within the selected context state set, the context state of the child node to be decoded is obtained based on the occupancy information of the context node of the child node to be decoded, that is, a probability P_{S} that the child node to be decoded is occupied (or unoccupied) is obtained under the current context situation.

In S204, entropy decoding parameter selection is performed.

First, for the intra prediction mode, an entropy decoding parameter set to be used, also referred to as a decoder group, is determined based on a context state set selected for the child node to be decoded, where each decoder includes an entropy decoding parameter. For the inter prediction mode, an entropy decoding parameter set to be used is determined based on the occupancy information of the prediction child node. A specific method is as shown in FIG. 9.

In a case that intra prediction is indicated, if an intra-frame non-sparse context state set (IntraNSparse state) is used, it is determined to use an intra-frame non-sparse entropy decoding parameter set (IntraNSparse Coder). If an intra-frame sparse context state set (IntraSparse state) is used, it is determined to use an intra-frame sparse entropy decoding parameter set (IntraSparse Coder).

In a case that inter prediction is indicated, and the current child node is unoccupied Pred0, it is determined to use an inter-frame entropy decoding parameter set InterPred0 Coder. In a case that inter prediction is indicated, and the current child node is occupied Pred1, it is determined to use an inter-frame entropy decoding parameter set InterPred1 Coder. In a case that inter prediction is indicated, and the current child node is strongly occupied PredL, it is determined to use an inter-frame entropy decoding parameter set InterPredL Coder. In other words, for inter prediction, sparse context states and non-sparse context states share the same entropy decoding parameter set, and the entropy decoding parameter set is selected only according to whether the node is predicted to be unoccupied, occupied, or strongly occupied. In this way, the correlation between inter-frame sparse context states and inter-frame non-sparse context states is fully utilized, thereby improving the inter prediction accuracy.

Specifically, based on the occupancy information of the prediction child node, information indicating that inter prediction is selected (isInter2=1) is classified into the following categories.
a) Pred0: When the prediction child node i is empty, the current child node i is predicted to be unoccupied bPi=0.
b) Pred1: When the prediction child node i is non-empty, the current child node i is predicted to be occupied bPi=1. In this case, there are the following two cases according to a quantity (Npred) of occupied nodes included in the prediction child node i.
i. predL=1: when the prediction child node i is non-empty and the quantity (Npred) of occupied nodes included in the prediction child node exceeds a first threshold th, the current child node i is strongly occupied.
ii. predL=0: when the prediction child node i is non-empty and the quantity (Npred) of occupied nodes included in the prediction child node does not exceed the first threshold th, the current child node i is not strongly occupied.

Second, in the determined decoder group, the context state P_{S} of bn is mapped to a decoder Ci according to a specific mapping rule. The mapping rule may be to extract the most significant five bits of the context state, where a value thereof serves as an index value of a mapped decoder, and a probability of the mapped decoder Ci is Pc.

In S205, adaptive arithmetic decoding is performed.

Adaptive arithmetic decoding is performed on the occupancy information bn of the to-be-decoded child node by using the probability Pc of the determined decoder Ci.

According to the decoding method provided in embodiments of this application, during inter prediction, the same decoder group is shared by both local sparse and local non-sparse categories, the best decoder group is selected for the current child node by fully utilizing inter prediction information, and the best entropy decoder is further selected, based on the context information, for decoding, thereby improving decoding efficiency. In addition, the same construction method may be used for inter-frame context information and intra-frame context information, and the quantity of inter-frame context states is the same as the quantity of intra-frame context states, which greatly reduces the quantity of inter-frame context states and saves storage space.

In another embodiment of this application, referring to FIG. 14, FIG. 14 is a schematic flowchart of an encoding method according to an embodiment of this application. As shown in FIG. 14, the method may include the following steps.

In S301, in a case that an inter prediction mode is enabled for a current child node, a target entropy encoding parameter set for the current child node is determined based on occupancy information of a prediction child node of the current child node in a reference frame.

It should be noted that, the current child node is any one of child nodes within a current node to be encoded. As shown in FIG. 7, the current node includes eight child nodes, and scanning order of the child nodes is the child node 0, child node 1, child node 2, child node 3, child node 4, child node 5, child node 6, and child node 7.

The prediction child node is a co-located child node of the current child node in a prediction node. The prediction node is a prediction node of the current node in the reference frame. Prediction information of the current node is determined based on occupancy information of the prediction node. The prediction node includes a plurality of prediction child nodes. Further, prediction information of the current child node may be determined based on occupancy information of the co-located prediction child node of the current child node. The occupancy information, also called position occupancy information or occupancy symbol. A value of the occupancy information is 0 or 1, where 0 indicates being unoccupied and 1 indicates being occupied.

The target entropy encoding parameter set includes a plurality of entropy encoding parameters. An entropy encoding parameter is used for performing entropy encoding on occupancy information of a child node. In some embodiments, the entropy encoding parameter may be an arithmetic encoding parameter, and adaptive arithmetic encoding is performed on occupancy information of a child node based on the arithmetic encoding parameter. For example, the arithmetic encoding parameter may be a probability that the current child node is occupied or unoccupied under any context information.

In some embodiments, the target entropy encoding parameter set for the current child node is determined from a plurality of entropy encoding parameter sets based on occupancy information of the prediction child node of the current child node in the reference frame. In other words, different entropy encoding parameter sets may be configured in advance for different inter prediction situations to improve inter prediction accuracy. When the inter prediction mode is enabled, a matched target entropy encoding parameter set is selected based on an actual inter prediction situation.

In some embodiments, the method further includes: determining, based on a value of a first syntax element, whether the inter prediction mode is allowed to be enabled for a current node; in a case that the inter prediction mode is allowed to be enabled for the current node, determining occupancy information of a prediction node of the current node in the reference frame; and determining whether the inter prediction mode is enabled for a child node of the current node based on the occupancy information of the prediction node, where the current child node is any one of child nodes within the current node.

Whether the inter prediction mode is enabled for the current child node is related to the value of the first syntax element and occupancy information of a prediction node of its parent node. The first syntax element, as an enable flag for inter prediction, is used to indicate whether upper-layer inter prediction is enabled. In some embodiments, in a case that the value of the first syntax element is a first numerical value, it is determined that the inter prediction mode is allowed to be enabled for the current node; and in a case that the value of the first syntax element is a second numerical value, it is determined that the inter prediction mode is not allowed to be enabled for the current node. For example, the first syntax element identifier includes at least a frame-level syntax element, where the value of 1 for the first syntax element indicates that inter prediction is allowed to be enabled, and a value of 0 for the first syntax element indicates that inter prediction is not allowed to be enabled.

In some embodiments, in a case that the occupancy information of the prediction node indicates being occupied, it is determined that the inter prediction mode is enabled for the current node; and in a case that the occupancy information of the prediction node indicates being unoccupied, it is determined that an intra prediction mode is enabled for the current node. For example, a value of 0 for the occupancy information indicates being unoccupied, and a value of 1 indicates being occupied. In other words, when the prediction node is occupied, inter prediction is enabled for the current node, so that prediction accuracy is improved by fully utilizing the inter prediction information. Otherwise, inter prediction is not enabled.

An occupancy state of the prediction node is related to an occupancy state of its child node. In some embodiments, the method further includes: determining occupancy information of a plurality of prediction child nodes in the prediction node; in a case that occupancy information of at least one prediction child node in the prediction node indicates being occupied, determining that the occupancy information of the prediction node indicates being occupied; and otherwise, determining that the occupancy information of the prediction node indicates being unoccupied. In other words, if at least one child node in the prediction node is occupied, the value of its occupancy information is set to 1. Conversely, if no child node is occupied, the value of its occupancy information is set to 0.

In some embodiments, the determining the target entropy encoding parameter set for the current child node based on the occupancy information of the prediction child node of the current child node in the reference frame includes: in a case that the occupancy information of the prediction child node indicates being unoccupied, determining that the target entropy encoding parameter set is a first entropy encoding parameter set; and in a case that the occupancy information of the prediction child node indicates being occupied, determining that the target entropy encoding parameter set is a second entropy encoding parameter set. In other words, an entropy encoding parameter set is assigned to the current child node based on an occupancy state of the prediction child node, where the first entropy encoding parameter set includes a plurality of entropy encoding parameters for the current child node when the prediction child node is unoccupied, and the second entropy encoding parameter set includes a plurality of entropy encoding parameters for the current child node when the prediction child node is occupied.

Further, when the occupancy information of the prediction child node indicates being occupied, the method further includes: determining occupancy strength of the prediction child node based on a quantity of occupied nodes in the prediction child node; and determining the second entropy encoding parameter set based on the occupancy strength. In other words, in a case that the prediction child node is occupied, the occupancy strength may be further divided into two or more occupancy strengths based on a quantity of occupied nodes in the prediction child node, thereby matching an appropriate entropy encoding parameter set based on the occupancy strength, and further improving prediction accuracy of the current child node.

In some embodiments, the determining the occupancy strength of the prediction child node based on the quantity of occupied nodes in the prediction child node includes: in a case that the quantity of occupied nodes in the prediction child node is greater than a first threshold, determining that the occupancy strength is strong occupancy; and in a case that the quantity of occupied nodes in the prediction child node is less than or equal to the first threshold, determining that the occupancy strength is occupancy.

For example, when the occupancy information of the prediction child node indicates being unoccupied, it is determined that the target entropy encoding parameter set is the first entropy encoding parameter set. When the occupancy information of the prediction child node indicates being occupied and the occupancy strength is strong occupancy, it is determined that the second entropy encoding parameter set is a strong occupancy entropy encoding parameter set. When the occupancy information of the prediction child node indicates being occupied and the occupancy strength is occupancy (also referred to as weak occupancy), it is determined that the second entropy encoding parameter set is an occupancy entropy encoding parameter set.

In S302, a target entropy encoding parameter for the current child node is determined from the target entropy encoding parameter set based on context information of the current child node.

The context information is related to occupancy information of a context node of the current child node. In some embodiments, the context information is constructed based on the occupancy information of the context node of the current child node and a target construction strategy.

In some embodiments, the target construction strategy includes: constructing the context information based on a preset context node scanning order and the occupancy information of the context node.

For example, the context node includes at least one of the following: an encoded sibling node of the current child node; an encoded neighboring child node sharing a face, an edge, or a vertex with the current child node; an encoded neighboring parent node sharing a face or an edge with the current child node; or another encoded neighbor node of the current child node. Scanning order of the context nodes may be: an encoded sibling node of the current child node>an encoded face-sharing child node neighbor of the current child node>an encoded edge-sharing child node neighbor of the current child node>an encoded vertex-sharing child node neighbor of the current child node>other encoded child node neighbors of the current child node>an encoded face-sharing parent node neighbor of the current child node>an encoded edge-sharing parent node neighbor of the current child node>other twenty encoded parent node neighbors. Context information is constructed for the to-be-encoded child node based on the scanning order and occupancy information.

In some other embodiments, the target construction strategy includes: constructing first information and second information in the context information based on a preset context information composition structure and the occupancy information of the context node, where a quantity of bits of the first information is fixed, and a quantity of bits of the second information is adjustable. Herein, the first information may be primary information, the second information may be secondary information, and whether part of the secondary information is used as context information is dynamically adjusted.

In some embodiments, the determining the target entropy encoding parameter for the current child node from the target entropy encoding parameter set based on the context information of the current child node includes: determining a context state of the current child node from a target context state set of the current child node based on the context information of the current child node, where the target context state set includes mapping relationships between a plurality of types of context information and context states; and determining the target entropy encoding parameter for the current child node from the target entropy encoding parameter set based on the context state of the current child node. Here, one or more types of context information correspond to one context state, and the context state is used to index a corresponding target entropy encoding parameter.

The target context state set includes mapping relationships between a plurality of types of context information and context states. For example, when the context information has 19 bits, there are at most 2¹⁹ states. When the context information has 16 bits, there are at most 2¹⁶ states. The target context state set is indexed according to the context information of the current child node, so as to determine the context state of the current child node. Further, the target entropy encoding parameter set is indexed according to the context state, so as to determine the target entropy encoding parameter for the current child node.

In some embodiments, the method may further include: determining a local sparsity category of the current child node based on occupancy information of encoded neighbor nodes of the current child node; and determining the target context state set of the current child node based on the local sparsity category.

The local sparsity category is used to indicate local sparsity of encoded neighbor nodes of the current child node. Different local sparsity categories correspond to different context state sets. In some embodiments, the determining the local sparsity category of the current child node based on the occupancy information of encoded neighbor nodes of the current child node includes: determining an occupancy quantity of the neighbor nodes based on the occupancy information of the neighbor nodes; and in a case that the occupancy quantity of the neighbor nodes is greater than a second threshold, determining that the local sparsity category of the current child node is a first category; or in a case that the occupancy quantity of the neighbor nodes is less than or equal to a second threshold, determining that the local sparsity category of the current child node is a second category.

In other words, the occupancy quantity (NN) of the neighbor nodes can be determined based on the occupancy information of the neighbor nodes (that is, whether they are occupied). Then, the local sparsity category of the current child node can be determined based on a result of comparison between the NN and the second threshold. The first category may be a non-sparse category, and the second category may be a sparse category.

The encoded neighbor nodes of the current child node may be the same or not completely the same as encoded context nodes of the current child node. For example, the neighbor node includes at least one of the following: an encoded sibling node of the current child node; an encoded neighboring child node adjacent to the current child node in a first preset direction; an encoded neighboring child node adjacent to the current child node in a second preset direction; or an encoded neighboring child node adjacent to the current child node in a third preset direction. The first preset direction may refer to a negative x-axis direction (left side Left direction) of the current child node, the second preset direction may refer to a negative y-axis direction (front side Front direction) of the current child node, and the third preset direction may refer to a negative z-axis direction (bottom side Bottom direction) of the current child node.

In some embodiments, the determining the target context state set of the current child node based on the local sparsity category includes: in a case that the local sparsity category is a first category, determining that the target context state set is a first context state set; and in a case that the local sparsity category is a second category, determining that the target context state set is a second context state set.

In some embodiments, the determining the target context state set of the current child node based on the local sparsity category includes: in a case that the inter prediction mode is enabled for the current child node, determining the target context state set of the current child node from an inter-frame context state set based on the local sparsity category; and in a case that an intra prediction mode is enabled for the current child node, determining the target context state set of the current child node from an intra-frame context state set based on the local sparsity category.

In embodiments of this application, the target context state set to be used is determined based on the local sparsity category and whether inter prediction is enabled. When the category is the non-sparse category and inter prediction is not used, an intra-frame non-sparse context state set (IntraNSparse state) is used. When the category is the sparse category and inter prediction is not used, an intra-frame sparse context state set (IntraSparse state) is used. When the category is the non-sparse category and inter prediction is used, an inter-frame non-sparse context state set (InterNSparse state) is used. When the category is the sparse category and inter prediction is used, an inter-frame sparse context state set (InterSparse state) is used.

In some embodiments, the method further includes: constructing a plurality of types of context information in the intra-frame context state set based on occupancy information of a context node and a first construction strategy, and initializing a context state for each type of context information; and constructing a plurality of types of context information in the inter-frame context state set based on occupancy information of a context node and a second construction strategy, and initializing a context state for each type of context information.

In embodiments of this application, the first construction strategy may include: constructing the context information based on a preset context node scanning order and the occupancy information of the context node; or constructing first information and second information in the context information based on a preset context information composition structure and the occupancy information of the context node, where a quantity of bits of the first information is fixed, and a quantity of bits of the second information is adjustable. The second construction strategy may include: constructing the context information based on a preset context node scanning order and the occupancy information of the context node; or constructing first information and second information in the context information based on a preset context information composition structure and the occupancy information of the context node, where a quantity of bits of the first information is fixed, and a quantity of bits of the second information is adjustable. The first construction strategy is the same as or different from the second construction strategy.

In some embodiments, the method further includes: in a case that an intra prediction mode is enabled for the current child node, determining the target entropy encoding parameter set for the current child node based on the local sparsity category. For example, in a case that the local sparsity category is the first category, it is determined that the target entropy encoding parameter set is a third entropy encoding parameter set; and in a case that the local sparsity category is the second category, it is determined that the target entropy encoding parameter set is a fourth entropy encoding parameter set. In other words, the intra prediction mode is enabled for the current child node, an entropy encoding parameter set is assigned based on the local sparsity category of the current child node, the third entropy encoding parameter set may include a plurality of entropy encoding parameters corresponding to the local non-sparse category, and the fourth entropy encoding parameter set may include a plurality of entropy encoding parameters corresponding to the local sparse category.

In some embodiments, the determining the target entropy encoding parameter for the current child node from the target entropy encoding parameter set based on the context state of the current child node includes: determining an index value of the target entropy encoding parameter based on the context state; and determining the target entropy encoding parameter for the current child node from the target entropy encoding parameter set based on the index value of the target entropy encoding parameter. In other words, in the target entropy encoding parameter set, according to a specific mapping rule, the context state is mapped to an index value of an entropy encoding parameter to index the target entropy encoding parameter.

In embodiments of this application, the entropy encoding parameter may include a probability of the current child node being occupied or unoccupied under the context information. In some embodiments, the context state may be an initial probability of the current child node being occupied (or unoccupied) under a current context situation. A large quantity of context states are mapped to a fixed quantity of probability models/context models, and arithmetic encoding is performed on the occupancy information of the current child node by using an indexed probability model, thereby improving encoding efficiency.

In some embodiments, the determining the index value of the target entropy encoding parameter based on the context state includes: determining the index value of the target entropy encoding parameter based on the most significant M bits of the context state, where M is related to a quantity of parameters in the target entropy encoding parameter set. For example, when the quantity N of parameters in the target entropy encoding parameter set is 32, the most significant five bits of the context state are used, and a value thereof serves as an index value of the target entropy encoding parameter.

In S303, entropy encoding is performed on occupancy information of the current child node based on the target entropy encoding parameter, and obtained encoded bits are written into a bitstream.

In some embodiments, the method further includes: updating the target entropy decoding parameter based on the occupancy information of the current child node.

In some embodiments, the method further includes: updating the context state based on the occupancy information of the current child node.

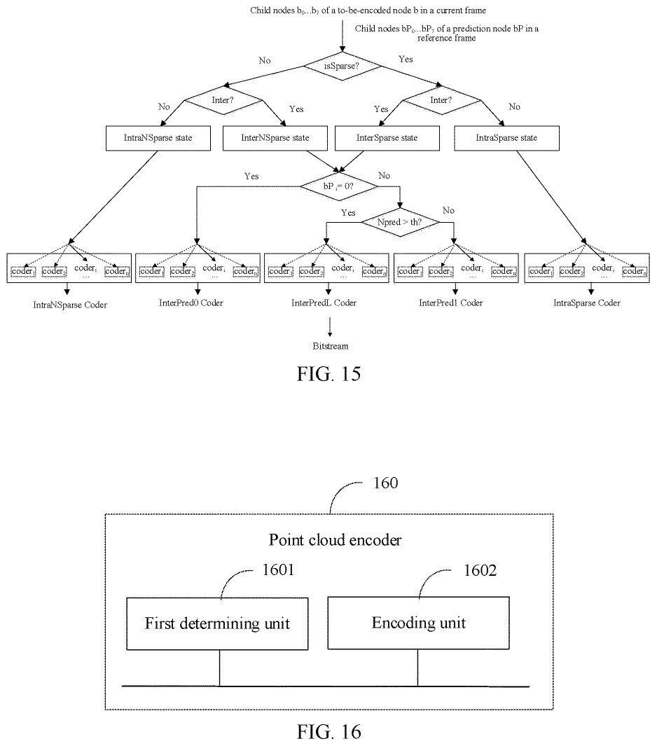

On the basis of the foregoing embodiments, the encoding method provided in embodiments of this application is further described by using examples. As shown in FIG. 15, the encoding method is specifically an encoding method for point cloud geometric information, and the method may include the following steps.

In S401, local sparsity is determined.

The local sparsity (isSparse) of the symbol bn to be encoded is determined based on the occupancy information of the encoded neighbor nodes. For example, local sparsity of the child node 0 is determined based on an occupancy quantity (NN) of 12 encoded child nodes adjacent to the current child node in the negative x-axis, y-axis, and z-axis directions, where the occupancy quantity NN>1 indicates being non-sparse (isSparse is 0), and the occupancy quantity NN≤1 indicates being sparse (isSparse is 1).

According to the value (0 or 1) of isSparse, context states may be classified into a sparse context state set and a non-sparse context state set.

In S402, whether to enable inter prediction is determined.

Whether to enable inter prediction is determined based on the occupancy information (predOcc) of the prediction node of the current node in the reference frame and the enable flag (isInter) for inter prediction, that is, a value of isInter2 is determined.

isInter2=isInter && predOcc, where the value of isInter2 is determined by isInter and predOcc, and predOcc is a flag used to indicate whether the prediction node is occupied. Specifically, if at least one child node bPi in the prediction node is occupied, predOcc is set to 1. Otherwise, if no child nodes are occupied, predOcc is 0. In addition, the value of isInter is controlled by a syntax element gbh.interPredictionEnabledFlag, and the syntax element is used to indicate whether upper-layer inter prediction is enabled. If inter prediction is enabled, the frame is referred to as a P-frame, and in this case, isInter is 1. Otherwise, if inter prediction is not enabled, the frame is referred to as an I-frame, and isInter is 0.

In S403, context state selection is performed.

First, a context state set to be used is determined based on the sparsity flag (isSparse) and the inter prediction flag (isInter2). When the category is the non-sparse category and inter prediction is not used, an intra-frame non-sparse context state set (IntraNSparse state) is used. When the category is the sparse category and inter prediction is not used, an intra-frame sparse context state set (IntraSparse state) is used. When the category is the non-sparse category and inter prediction is used, an inter-frame non-sparse context state set (InterNSparse state) is used. When the category is the sparse category and inter prediction is used, an inter-frame sparse context state set (InterSparse state) is used. A method for constructing the context information in the intra-frame non-sparse context state set (IntraNSparse state), the intra-frame sparse context state set (IntraSparse state), the inter-frame non-sparse context state set (InterNSparse state), and the inter-frame sparse context state set (InterSparse state) may be the construction method in OBUF, or the construction method in dynamic OBUF.

It should be noted that, compared to a method for constructing inter-frame context information in the prior art, two bits of inter prediction information is added to intra-frame context information, and a quantity of inter-frame context states is four times that of intra-frame context states, thereby requiring a large amount of storage space. The inter-frame context construction method in the embodiments of this application may be the same as the intra-frame context construction method, without using inter prediction information for construction, thereby reducing a quantity of inter-frame context states, saving storage space, and improving encoding efficiency.

Second, within the selected context state set, the context state of the child node to be encoded is obtained based on the occupancy information of the context node of the child node to be encoded, that is, a probability P_{S} that the child node to be encoded is occupied (or unoccupied) is obtained under the current context situation.

In S404, entropy encoding parameter selection is performed.

First, for the intra prediction mode, an entropy encoding parameter set to be used, also referred to as an encoder group, is determined based on a context state set selected for the child node to be encoded, where each encoder includes an entropy encoding parameter. For the inter prediction mode, an entropy encoding parameter set to be used is determined based on the occupancy information of the prediction child node. A specific method is as shown in FIG. 9.

In a case that intra prediction is selected, if an intra-frame non-sparse context state set (IntraNSparse state) is used, it is determined to use an intra-frame non-sparse encoder group (IntraNSparse Coder). If an intra-frame sparse context state set (IntraSparse state) is used, it is determined to use an intra-frame sparse encoder group (IntraSparse Coder).

In a case that inter prediction is selected, and the node is unoccupied Pred0, it is determined to use an inter-frame encoder group InterPred0 Coder. In a case that inter prediction is selected, and the node is occupied Pred1, it is determined to use an inter-frame encoder group InterPred1 Coder. In a case that inter prediction is selected, and the node is strongly occupied PredL, it is determined to use an inter-frame encoder group InterPredL Coder. In other words, for inter prediction, sparse context states and non-sparse context states share the same entropy encoding parameter set, and the entropy encoding parameter set is selected only according to whether the node is predicted to be unoccupied, occupied, or strongly occupied. In this way, the correlation between inter-frame sparse context states and inter-frame non-sparse context states is fully utilized, thereby improving the inter prediction accuracy.

Specifically, based on the occupancy information of the prediction child node, information indicating that inter prediction is selected (isInter2=1) is classified into the following categories.
a) Pred0: When the prediction child node i is empty, the current child node i is predicted to be unoccupied bPi=0.
b) Pred1: When the prediction child node i is non-empty, the current child node i is predicted to be occupied bPi=1. In this case, there are the following two cases according to a quantity (Npred) of occupied nodes included in the prediction child node i.
i. predL=1: when the prediction child node i is non-empty and the quantity (Npred) of occupied nodes included in the prediction child node exceeds a first threshold th, the current child node i is strongly occupied.
ii. predL=0: when the prediction child node i is non-empty and the quantity (Npred) of occupied nodes included in the prediction child node does not exceed the first threshold th, the current child node i is not strongly occupied.

Second, in the determined encoder group, the context state PS of bn is mapped to an encoder Ci according to a specific mapping rule. The mapping rule may be to extract the most significant five bits of the context state, where a value thereof serves as an index value of a mapped encoder, and a probability of the mapped encoder Ci is Pc.

In S405, adaptive arithmetic encoding is performed.

Adaptive arithmetic encoding is performed on the occupancy information bn of the to-be-encoded child node by using the probability Pc of the determined encoder Ci.

According to the encoding method provided in embodiments of this application, during inter prediction, the same encoder group is shared by both local sparse and local non-sparse categories, the best encoder group is selected for the current child node by fully utilizing inter prediction information, and the best entropy encoder is further selected, based on the context information, for encoding, thereby improving encoding efficiency. In addition, the same construction method may be used for inter-frame context information and intra-frame context information, and the quantity of inter-frame context states is the same as the quantity of intra-frame context states, which greatly reduces the quantity of inter-frame context states and saves storage space.

According to the encoding method and decoding method provided in embodiments of this application, inter prediction information is fully utilized, thereby further improving G-PCC geometry encoding efficiency. Table 9 shows BD-Rate under lossy geometric information compression conditions, representing a percentage by which an encoding bit rate of this application is reduced (when the BD-Rate is negative) or increased (when the BD-Rate is positive), compared to the prior art, under the condition of obtaining the same encoding quality.

TABLE 9
BD-rate of GES-TM-v3.0 lossy compression

| | Lossy geometry, lossy attributes | | | | |
|---|---|---|---|---|---|
| | | | | Geom. BD- | |
| | End-toEnd BD-AttrRate[%] | | | TotGeomRate[%] | |
| C2 | Y | U | V | D1 | D2 |
| Cat2-A average | 0.0% | 0.0% | 0.0% | −2.8998% | −2.9037% |
| Cat2-B average | 0.0% | 0.0% | 0.0% | −3.0278% | −3.1043% |
| Cat2-B average | 0.0% | 0.0% | 0.0% | −2.9718% | −2.9979% |
| Overall | 0.0% | 0.0% | 0.0% | −2.9386% | −2.9593% |
| average | | | | | |

In another embodiment of this application, based on a same invention concept as the foregoing embodiments, FIG. 16 is a schematic structural diagram of a point cloud encoder according to this embodiment of this application. As shown in FIG. 16, the point cloud encoder 160 may include a first determining unit 1601 and an encoding unit 1602.

The first determining unit 1601 is configured to: in a case that an inter prediction mode is enabled for a current child node, determine a target entropy encoding parameter set for the current child node based on occupancy information of a prediction child node of the current child node in a reference frame; determine a target entropy encoding parameter for the current child node from the target entropy encoding parameter set based on context information of the current child node.

The encoding unit 1602 is configured to perform entropy encoding on occupancy information of the current child node based on the target entropy encoding parameter, and write obtained encoded bits into a bitstream.

It may be understood that each functional unit of the point cloud encoder further performs the encoding method described in any one of the foregoing embodiments.

It may be understood that in embodiments of this application, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or a part of the technical solutions may be implemented in a form of a software product. The computer software product is stored in a storage medium and includes several instructions for instructing a computer device (which may be a personal computer, a server, or a network device) or a processor to execute all or a part of the steps of the methods described in the embodiments. The foregoing storage medium includes various media that may store a program code, such as a USB flash drive, a removable hard disk, a read-only memory (ROM), a random access memory (RAM), a magnetic disk, or an optical disc.

Therefore, an embodiment of this application provides a computer-readable storage medium, applied to a point cloud encoder 160. The computer-readable storage medium stores a computer program, and the computer program is executed by a first processor to implement the encoding method according to any one of the foregoing embodiments.

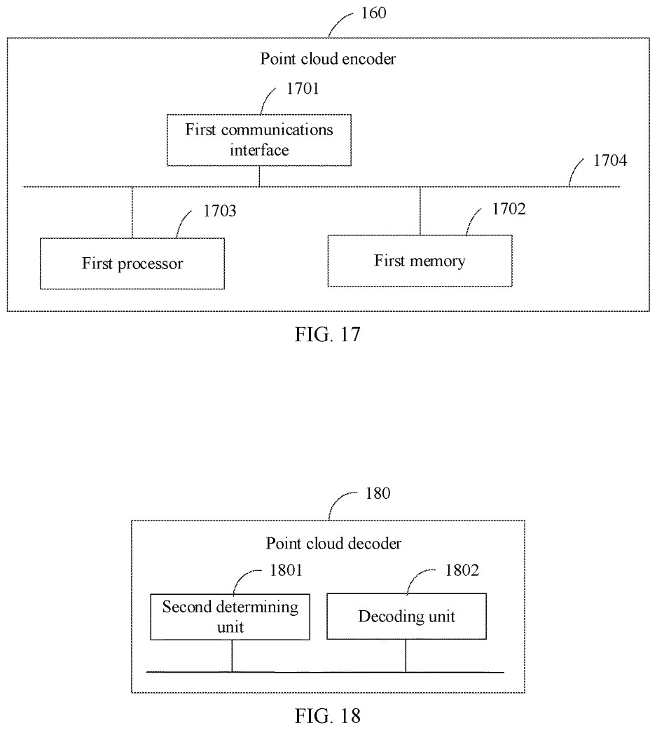

Based on the composition of the point cloud encoder 160 and the computer-readable storage medium, FIG. 17 is a schematic diagram of a structure of specific hardware of the point cloud encoder 160 according to an embodiment of this application. As shown in FIG. 17, the point cloud encoder 160 may include a first communications interface 1701, a first memory 1702, and a first processor 1703. The components are coupled together by using a first bus system 1704. It may be understood that the first bus system 1704 is configured to implement connection and communication between these components. The first bus system 1704 may further include a power bus, a control bus, a status signal bus, and the like in addition to a data bus. However, for clarity of description, various buses are all marked as the first bus system 1704 in FIG. 17.

The first communications interface 1701 is configured to receive and transmit signals in the process of transmitting and receiving information with other external network elements.

The first memory 1702 is configured to store a computer program runnable on the first processor 1703.

The first processor 1703 is configured to run the computer program to execute the following operations:
determining occupancy information of a reference child node of a current child node;
determining preset identifier information of the current child node based on the occupancy information of the reference child node;
determining context information of the current child node based on the preset identifier information; and
encoding a value of a to-be-encoded syntax element of the current child node based on the context information, and writing obtained encoded bits into a bitstream.

It may be understood that, in embodiments of this application, the first memory 1702 may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example rather than limitative description, many forms of RAMs are available, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct Rambus random access memory (DRRAM). The first memory 1702 in the systems and the methods described in this application includes but is not limited to these memories and any memory of another appropriate type.

However, the first processor 1703 may be an integrated circuit chip having a signal processing capability. In an implementation process, steps in the foregoing method can be implemented by using a hardware integrated logical circuit in the first processor 1703, or by using instructions in a form of software. The foregoing first processor 1703 may be a general-purpose processor, a digital signal processor (DSP), an application-specific integrated circuit (ASIC), a field-programmable gate array (FPGA) or another programmable logic device, a discrete gate or transistor logic device, or a discrete hardware component. The processor can implement or execute the methods, steps and logical block diagrams disclosed in embodiments of this application. The general-purpose processor may be a microprocessor, or the processor may be any conventional processor or the like. The steps of the methods disclosed with reference to embodiments of this application may be directly completed by a hardware decoding processor, or may be completed by a combination of hardware and software modules in a decoding processor. The software module may be located in a mature storage medium in the art, for example, a random access memory, a flash memory, a read-only memory, a programmable read-only memory, an electrically erasable programmable memory, or a register. The storage medium is located in the first memory 1702, and the first processor 1703 reads information in the first memory 1702 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (ASIC), digital signal processors (DSP), digital signal processing devices (DSPD), programmable logic devices (PLD), field-programmable gate arrays (FPGA), general-purpose processors, controllers, microcontrollers, microprocessors, and other electronic units configured to execute the functions described in this application, or a combination thereof. For software implementation, the technologies described in this application can be implemented by modules (such as processes and functions) that execute the functions described in this application. Software code may be stored in a memory and executed by a processor. The memory can be implemented in the processor or outside the processor.

Optionally, in another embodiment, the first processor 1703 is further configured to execute the encoding method in any one of the foregoing embodiments when running the computer program.

An embodiment provides a point cloud encoder, in this point cloud encoder, an actual meaning may be assigned to the identifier information in the context information, and an encoded symbol bit may be made valid. Thus, accuracy of constructing context information can be improved to select the best target point cloud encoder for encoding. In this way, encoding and decoding performance can be maintained, and encoding and decoding efficiency can also be improved.

An embodiment of this application further provides a computer-readable storage medium, where the computer-readable storage medium stores a bitstream generated by using the encoding method according to any one of the foregoing embodiments. The bitstream is generated by performing bit encoding on to-be-encoded information; and the to-be-encoded information includes at least occupancy information of the current child node.

In another embodiment of this application, based on a same invention concept as the foregoing embodiments, FIG. 18 is a schematic structural diagram of a point cloud decoder according to this embodiment of this application. As shown in FIG. 18, the point cloud decoder 180 may include a second determining unit 1801 and a decoding unit 1802.

The second determining unit 1801 is configured to: in a case that an inter prediction mode is enabled for a current child node, determine a target entropy decoding parameter set for the current child node based on occupancy information of a prediction child node of the current child node in a reference frame; and determine a target entropy decoding parameter for the current child node from the target entropy decoding parameter set based on context information of the current child node.

The decoding unit 1802 is configured to perform entropy decoding on a bitstream based on the target entropy decoding parameter to determine occupancy information of the current child node.

It may be understood that each functional unit of the point cloud decoder further performs the decoding method described in any one of the foregoing embodiments.

It may be understood that in embodiments, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment provides a computer-readable storage medium, applied to the point cloud decoder 180. The computer-readable storage medium stores a computer program, and the computer program is executed by a second processor to implement the decoding method according to any one of the foregoing embodiments.

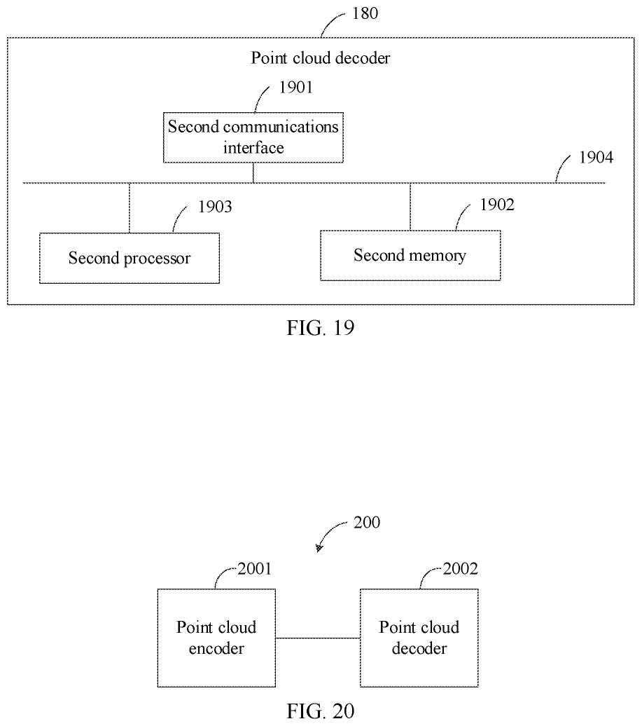

Based on the composition of the point cloud decoder 180 and the computer-readable storage medium, referring to FIG. 19, FIG. 19 is a schematic diagram of a structure of specific hardware of the point cloud decoder 180 according to an embodiment of this application. As shown in FIG. 19, the point cloud decoder 180 may include a second communications interface 1901, a second memory 1902, and a second processor 1903. Various components are coupled together by using a second bus system 1904. It may be understood that the second bus system 1904 is configured to implement connection and communication between these components. The second bus system 1904 may further include a power bus, a control bus, a status signal bus, and the like, in addition to a data bus. However, for clarity of description, various buses are all marked as the second bus system 1904 in FIG. 19.

The second communications interface 1901 is configured to receive and transmit a signal in a process of transmitting and receiving information between the second communications interface and another external network element.

The second memory 1902 is configured to store a computer program runnable on the second processor 1903.

The second processor 1903 is configured to run the computer program to execute the following operations:
determining occupancy information of a reference child node of a current child node;
determining preset identifier information of the current child node based on the occupancy information of the reference child node;
determining context information of the current child node based on the preset identifier information; and
decoding a to-be-decoded syntax element of the current child node based on the context information, and determining a value of the to-be-decoded syntax element.

Optionally, in another embodiment, the second processor 1903 is further configured to run the computer program to perform the decoding method according to any one of the foregoing embodiments.

It may be understood that hardware functions of the second memory 1902 are similar to those of the first memory 1702, and hardware functions of the second processor 1903 are similar to those of the first processor 1703, which is not detailed here.

An embodiment provides a point cloud decoder, in this point cloud decoder, an actual meaning may be assigned to the identifier information in the context information, and a decoded symbol bit may be made valid. Thus, accuracy of constructing context information can be improved to select the best target point cloud decoder for decoding. In this way, encoding and decoding performance can be maintained, and encoding and decoding efficiency can also be improved.

In another embodiment of this application, referring to FIG. 20, FIG. 20 is a schematic structural diagram of an encoding and decoding system according to this embodiment of this application. As shown in FIG. 20, the encoding and decoding system 200 may include a point cloud encoder 2001 and a point cloud decoder 2002.

In embodiments of this application, the point cloud encoder 2001 may be the point cloud encoder according to any one of the foregoing embodiments, and the point cloud decoder 2002 may be the point cloud decoder according to any one of the foregoing embodiments.

It should be noted that, in this application, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of further restrictions, the element limited by the sentence “including a . . . ” does not exclude the existence of other identical elements in the process, method, item or device including this element.

The foregoing sequence numbers of embodiments of this application are merely described, and do not represent advantages or disadvantages of the embodiments.

The disclosed methods provided in the several method embodiments of this application may be randomly combined with each other in the case of no conflicts, to obtain new method embodiments. The disclosed features provided in the several product embodiments of this application may be randomly combined with each other in the case of no conflicts, to obtain new product embodiments. The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### INDUSTRIAL PRACTICALITY

In embodiments of this application, on an encoding side, in a case that the inter prediction mode is enabled for the current child node, the target entropy encoding parameter set for the current child node is determined based on the occupancy information of the prediction child node of the current child node in the reference frame; the target entropy encoding parameter for the current child node is determined from the target entropy encoding parameter set based on the context information of the current child node; and entropy encoding is performed on the occupancy information of the current child node based on the target entropy encoding parameter, and obtained encoded bits are written into a bitstream. At a decoding end, the target entropy decoding parameter is determined by using the same method, so as to perform entropy decoding on the occupancy information. In this way, during inter prediction, the best entropy encoding/decoder parameter set is selected for the current child node by fully utilizing inter prediction information, and the best entropy encoding/decoder parameter is further selected, based on the context information, for encoding, thereby reducing a bit rate and improving encoding and decoding efficiency.

What is claimed is:

1. A decoding method, applied to a point cloud decoder, wherein the method comprises:
in a case that an inter prediction mode is enabled for a current child node, determining a target entropy decoding parameter set for the current child node based on occupancy information of a prediction child node of the current child node in a reference frame;
determining a target entropy decoding parameter for the current child node from the target entropy decoding parameter set based on context information of the current child node; and
performing entropy decoding on a bitstream based on the target entropy decoding parameter to determine occupancy information of the current child node.

2. The method according to claim 1, wherein the determining the target entropy decoding parameter set for the current child node based on the occupancy information of the prediction child node of the current child node in the reference frame comprises:
in a case that the occupancy information of the prediction child node indicates being unoccupied, determining that the target entropy decoding parameter set is a first entropy decoding parameter set; and
in a case that the occupancy information of the prediction child node indicates being occupied, determining that the target entropy decoding parameter set is a second entropy decoding parameter set.

3. The method according to claim 2, wherein in a case that the occupancy information of the prediction child node indicates being occupied, the method further comprises:
determining occupancy strength of the prediction child node based on a quantity of occupied nodes in the prediction child node; and
determining the second entropy decoding parameter set based on the occupancy strength; and
the determining the occupancy strength of the prediction child node based on the quantity of occupied nodes in the prediction child node comprises:
in a case that the quantity of occupied nodes in the prediction child node is greater than a first threshold, determining that the occupancy strength is strong occupancy; and
in a case that the quantity of occupied nodes in the prediction child node is less than or equal to the first threshold, determining that the occupancy strength is occupancy.

4. The method according to claim 1, wherein the method further comprises:
constructing the context information based on occupancy information of a context node of the current child node and a target construction strategy; and
the target construction strategy comprises: constructing the context information based on a preset context node scanning order and the occupancy information of the context node;
or, the target construction strategy comprises: constructing first information and second information in the context information based on a preset context information composition structure and the occupancy information of the context node, wherein a quantity of bits of the first information is fixed, and a quantity of bits of the second information is adjustable.

5. The method according to claim 1, wherein the determining the target entropy decoding parameter for the current child node from the target entropy decoding parameter set based on the context information of the current child node comprises:
determining a context state of the current child node from a target context state set of the current child node based on the context information of the current child node, wherein the target context state set comprises mapping relationships between a plurality of types of context information and context states; and
determining the target entropy decoding parameter for the current child node from the target entropy decoding parameter set based on the context state of the current child node.

6. The method according to claim 5, wherein the method further comprises:
determining a local sparsity category of the current child node based on occupancy information of decoded neighbor nodes of the current child node; and
determining the target context state set of the current child node based on the local sparsity category.

7. The method according to claim 6, wherein the determining the local sparsity category of the current child node based on the occupancy information of the decoded neighbor nodes of the current child node comprises:
determining an occupancy quantity of the neighbor nodes based on the occupancy information of the neighbor nodes; and
in a case that the occupancy quantity of the neighbor nodes is greater than a second threshold, determining that the local sparsity category of the current child node is a first category; or
in a case that the occupancy quantity of the neighbor nodes is less than or equal to a second threshold, determining that the local sparsity category of the current child node is a second category.

8. The method according to claim 6, wherein the neighbor node comprises at least one of following:
a decoded sibling node of the current child node;
a decoded neighboring child node adjacent to the current child node in a first preset direction;
a decoded neighboring child node adjacent to the current child node in a second preset direction; or
a decoded neighboring child node adjacent to the current child node in a third preset direction.

9. The method according to claim 6, wherein the determining the target context state set of the current child node based on the local sparsity category comprises:
in a case that the local sparsity category is a first category, determining that the target context state set is a first context state set; and
in a case that the local sparsity category is a second category, determining that the target context state set is a second context state set.

10. The method according to claim 6, wherein the determining the target context state set of the current child node based on the local sparsity category comprises:
in a case that the inter prediction mode is enabled for the current child node, determining the target context state set of the current child node from an inter-frame context state set based on the local sparsity category; and
in a case that an intra prediction mode is enabled for the current child node, determining the target context state set of the current child node from an intra-frame context state set based on the local sparsity category.

11. The method according to claim 10, wherein the method further comprises:
constructing a plurality of types of context information in the intra-frame context state set based on occupancy information of a context node and a first construction strategy, and initializing a context state for each type of context information; and
constructing a plurality of types of context information in the inter-frame context state set based on occupancy information of a context node and a second construction strategy, and initializing a context state for each type of context information.

12. The method according to claim 11, wherein the context node comprises at least one of following:
a decoded sibling node of the current child node;
a decoded neighboring child node sharing a face, an edge, or a vertex with the current child node;
a decoded neighboring parent node sharing a face or an edge with the current child node; or
another decoded neighbor node of the current child node.

13. The method according to claim 6, wherein the method further comprises:
in a case that an intra prediction mode is enabled for the current child node, determining the target entropy decoding parameter set for the current child node based on the local sparsity category.

14. The method according to claim 13, wherein the determining the target entropy decoding parameter set for the current child node based on the local sparsity category comprises:
in a case that the local sparsity category is a first category, determining that the target entropy decoding parameter set is a third entropy decoding parameter set; and
in a case that the local sparsity category is a second category, determining that the target entropy decoding parameter set is a fourth entropy decoding parameter set.

15. The method according to claim 5, wherein the determining the target entropy decoding parameter for the current child node from the target entropy decoding parameter set based on the context state of the current child node comprises:
determining an index value of the target entropy decoding parameter based on the context state; and
determining the target entropy decoding parameter for the current child node from the target entropy decoding parameter set based on the index value of the target entropy decoding parameter.

16. The method according to claim 15, wherein the determining the index value of the target entropy decoding parameter based on the context state comprises:
determining the index value of the target entropy decoding parameter based on the most significant M bits of the context state, wherein M is related to a quantity of parameters in the target entropy decoding parameter set.

17. The method according to claim 1, wherein the target entropy decoding parameter comprises a probability that the current child node is occupied or not occupied under the context information.

18. The method according to claim 17, wherein after the performing entropy decoding on the bitstream based on the target entropy decoding parameter to determine the occupancy information of the current child node, the method further comprises:
updating the target entropy decoding parameter based on the occupancy information of the current child node.

19. An encoding method, applied to a point cloud encoder, wherein the method comprises:
in a case that an inter prediction mode is enabled for a current child node, determining a target entropy encoding parameter set for the current child node based on occupancy information of a prediction child node of the current child node in a reference frame;
determining a target entropy encoding parameter for the current child node from the target entropy encoding parameter set based on context information of the current child node; and
performing entropy encoding on occupancy information of the current child node based on the target entropy encoding parameter, and writing obtained encoded bits into a bitstream.

20. A non-transitory computer-readable storage medium, having a computer program and a bitstream stored thereon, wherein the computer program, when executed by a processor, enables the processor to perform the steps of the encoding method of claim 19 to generate the bitstream.
